(19) United States
(12) Patent Application Publication
(10) Pub. No.: US 2016/0021092 A1
(43) Pub. Date: Jan. 21, 2016

(54) SYSTEM AND METHOD FOR MANAGING HETEROGENEOUS COMPUTING ENVIRONMENTS

(71) Applicant: BASIC6, INC., Westport, CT (US)

(72) Inventors: Edward SAMSON, Westpm (IS); Magnus WENNEMYR, Amherst, MA (US)

(21) Appl. No.: 14/849,786

(22) Filed: Sep. 10, 2015

Related U.S. Application Data
(62) Division of application No. 14/265,146, filed on Apr. 29, 2014.
(60) Provisional application No. 61/817,107, filed on Apr. 29, 2013.
(60) Provisional application No. 61/972,754, filed on Mar. 31, 2014.

(51) Int. Cl. H04L 29/06; H04L 29/08

(52) U.S. Cl. CPC H04L 63/083; H04L 67/1002

(57) ABSTRACT

A system for transferring data, in the form of files, from a first location in the cloud to a second location in the cloud includes storage for credentials to allow the system to access the data in a plurality of locations in the cloud; storage for data accessed in a first location in the cloud; and data transfer components for transferring the data accessed at the first location to a second location in the cloud. A method for transferring data stored in the cloud, includes providing credentials to a service to allow the service to access the data in a plurality of locations in the cloud; using the service to access data stored in a first location in the cloud; and using the service to transfer the data accessed at the first location to a second location in the cloud.

### CROSS-REFERENCED APPLICATIONS

This application is a divisional of application Ser. No. 14/265,146 filed on Apr. 29, 2014, which claims priority from and the benefit of provisional patent application Ser. Nos. 61/817,107 filed on Apr. 29, 2013, and 61/972,754 filed on Mar. 31, 2014. The entire contents of these applications are incorporated herein by reference, for all purposes.

### BACKGROUND OF THE DISCLOSURE

1. Field of the Disclosure

The present disclosure relates to systems and methods for managing heterogeneous systems and methods for managing heterogeneous computing environments and, in particular, to systems and methods for providing a task management framework for increasing the efficiency in which heterogeneous computing environments are managed in the data center and in the cloud.

2. Description of the Related Art

Generally speaking, it is estimated that over sixty percent (60%) of enterprises that have a mixed or heterogeneous computing environment of systems having Windows and non-Windows operating systems (Windows is a registered trademark of Microsoft Corporation, Redmond, Wash. USA). Furthermore, smaller microprocessor-based devices are overwhelmingly based on non-Windows operating systems. Enterprises that have such environments are either currently evaluating or have deployed enterprise wide Identity and Access Management Solutions for the heterogeneous computing environment. However, a large percentage of the enterprises have identified a need for a task management tool having features and functions similar to Microsoft Active Directory to assist in managing their non-Windows environments such as, for example, UNIX, LINUX, and Macintosh environments in the data center and in the cloud. Presently, administrators of non-Windows environments have been managing local accounts, groups and file systems using command line interfaces and disparate consoles that are inefficient, error prone and difficult to use.

For example, the inventor has recognized that perceived problems in the conventional mixed environment of Windows and non-Windows systems, include:

Delegation of account, group and file system management requires that a highly skilled staff be trained and trusted for it is easy to grant super user privileges to accounts that do not require root access.

Auditing of account, group and file system activities is lacking as it is common for account administration on the Unix/Linux/Macintosh host to not be audited thus making it difficult for identifying who added, changed files or removed accounts, groups and group members.

Exposure to new security threats increases at least since once a non-Windows host has been joined to Active Directory, a new set of threats exist for privilege escalation and denial of service attacks. Both of these threats exist because administrators have a terminal access (command line access) to the non-Windows host.

Insofar as attempts have been made to resolve the issue of control of remote systems, these rely on the installation of agents on target systems, providing an additional potential point of failure, and an additional management task.

Enterprise Wide Local Account, Group, Services and Programs, Device Hardware, and File System Management is lacking as enterprises have no easy way of reporting on the thousands of local accounts, groups, services, programs and their versions, and file systems that reside on the non-Windows hosts.

A further difficulty is that execution of scripts and commands against multiple target servers or devices, one by one, is error-prone.

In addition, controls are not conveniently extended to hardware such as micro-controllers and blue-tooth emitters residing on devices which have their own micro-processor.

Another issue concerns cloud storage. A Cloud storage service is an online user file storage provider hosted on the Internet. It allows users to upload files that can then be accessed via the Internet from a different end point device, by the same user or possibly by other users, after an appropriate password or other authentication is provided. A user interface for such services is made available by the provider so that user actions can be implemented by operating with an API hosted “in the cloud”.

Each individual Cloud Storage Service (e.g. DropBox, Google Drive, Box, Amazon S3, iCloud) provides an API for uploading and downloading files, but since it is in the interest of each individual provider to retain a user's content, there is no generic way to transfer files from one service to another. Such transfers are desirable when pricing or policy changes occur that make one provider preferable over another, or to provide redundancies of data in order to ensure data integrity and availability by duplicating the data across systems.

Such transfers can be accomplished by an individual downloading the files onto their local system from the originating service, and then uploading the same data to a different destination service. There are four issues with respect to this approach. First, for each action, several steps are typically required, resulting in two sets of actions (corresponding to the download and subsequent upload), resulting in multiple points when errors can be introduced by the user. Second, each set of steps is carried out in two different user interfaces, each corresponding to a different provider, making the process onerous to the user. Third, for each step, the user's own computing resources (device and internet access channel) is engaged during what can be a lengthy process for sizeable amounts of data. Fourth, it is not possible to schedule transfers without the engagement of the user's own device, which provides temporary storage during the transfer.

Thus, it would be advantageous if there were another way to transfer data and files from one cloud storage facility to another.

### SUMMARY OF THE DISCLOSURE

In view of the above, the inventors herein have recognized the marked advantages of leveraging currently implemented Windows-based tools such as Microsoft Active Directory, Microsoft Windows, Secure Shell Technology and the currently implemented enterprise wide Identity and Access Management Solutions and vendor APIs into a task management tool for increasing the efficiency of task management in non-Windows as well as Windows environments in the data center, in small devices, and the cloud. This can be done, in part, by providing the ability to execute actions against groups of potentially heterogeneous targets.

In general, an embodiment of the disclosure is directed to a framework for managing heterogeneous computing environments, comprising at least a first computing device having a Windows based operating system; at least a second computing device, be it a full server or a small micro-processor based device, having a non-Windows or Windows based operating environment; and a framework module for providing account management, group management, file system management, event log management and security management. The framework module can include a secure store technology component and a task automation framework; wherein the task automation framework is interchangeable to provide at least one of a plurality of functions.

The plurality of functions provided by the task automation framework includes at least one of certificates management, computer management, device management, disk defragmentation, disk management, syslog management, IP security monitoring, performance logging and alerts, power management, management of hardware on the same device but external to the microprocessor of the device and its associated memory, removable storage management, security configuration and analysis, and process management.

The secure store technology component is preferably a Windows based file system that is integrated to administrative tasks for controlling and managing non-Windows and Windows based systems in a remote fashion.

An embodiment of the disclosure is directed to a management console, comprising a user interface; at least one control processing module; a task translation subsystem for translating commands suitable for a first operating system to commands suitable for a second operating system; an execution engine for transmitting the commands for execution on a remote system; and a secure communications layer for sending the commands to the remote system.

The secure communications layer receives data from the remote system in response to one or more of the commands. The secure communications layer also receives at least one of error indications and information indicating success of an operation from the remote system in response to one or more of the commands.

An embodiment of the disclosure is directed to a method of operating a management console, comprising providing control input; processing the input; translating commands suitable for a first operating system to commands suitable for a second operating system; transmitting the commands for execution on a remote system; and securely sending the commands to the remote system.

It is noted that the present design generally does not rely on the installation of agents on target systems, but instead relies on and exploits proven and secure facilities inherent within the target operating systems.

Yet another embodiment of the disclosure is directed to a computer readable non-transitory storage medium storing instructions of a computer program which when executed by a computer system results in performance of steps of a method for operating a management console, comprising providing control input to the management console; processing the input; translating commands suitable for a first operating system to commands suitable for a second operating system; transmitting the commands for execution to a remote system; and securely sending the commands to the remote system.

Another aspect of the disclosed embodiments is directed to a cloud file transfer service. The cloud file transfer service can be hosted outside of user's domain by a separate party. A single request is made by the user for the transfer. The files are requested on the user's behalf from the service, and the files are sent on the user's behalf to the destination service. Credentials are provided to the transfer service so that it may act on the user's behalf. It is preferable that the cloud file transfer service receives only tokens for access, instead of the user's actual account password. The tokens may be revoked if necessary.

### BRIEF DESCRIPTION OF THE DRAWINGS

FIG. 1 is a block diagram of system using a Cloud Management Console.

FIG. 1A is a block diagram illustrating the integration of a Cloud Management Administrator into the Cloud Management Console of FIG. 1.

FIG. 2 is an example of an example of a graphical user interface used by a system administrator to manage a Task Execution Framework.

FIG. 3 is an example of the graphical user interface of a Microsoft Management Console.

FIG. 4 is an example of a terminal window associated with a snap-in to the Microsoft Management Console.

FIG. 5 is an example of Secure Storage Technology

FIG. 6 is an illustration of one embodiment of node security.

FIG. 7 is an illustration of node inheritance as it applies to networked servers.

FIG. 7A is an illustration of node inheritance as it applies to cloud service assets.

FIG. 8 is an illustration of a user interface where security settings may be applied to a node.

FIG. 9 is a flow chart of the authorization flow for objects in an SST enabled console.

FIG. 10 is a flow chart of the flow for auditing the Event Log within an SST enabled console.

FIG. 11 illustrates the merger of technologies used for management of non-Microsoft systems from a Microsoft desktop.

FIG. 12 is a block diagram illustrating how the management console of the present disclosure is received in a system.

FIG. 13 is a block diagram of major components of the present system.

FIG. 14 is a flow chart of how the management console communicates with various servers.

FIG. 15 is a continuation of the flow chart of FIG. 14.

FIG. 16 is a block diagram of the task translation subsystem of FIG. 13.

FIG. 17 is a block diagram of the control processing subsystem of FIG. 13.

FIG. 18 is a block diagram of the execution engine subsystem of FIG. 13.

FIG. 19 depicts secure control of microprocessor-based devices.

FIG. 20 is a flow chart of the flow for auditing the Event Log within an SST enabled console

FIG. 21 is a diagram of the data flow and operation of the task translation subsystem of FIG. 20.

FIG. 22 illustrates the manner in which the user experience is managed with the control processing modules of FIG. 20.

FIG. 23 illustrates the operation of the execution engine of FIG. 22.

FIG. 24 is a block diagram of how the present apparatus fits generally into cloud computing.

FIG. 24A is a flow diagram of cloud data and file transfer service.

FIG. 25 is a block diagram of how the present apparatus fits into specific instances of cloud computing.

FIG. 26A and FIG. 26B are screen shots of how remote asset (e.g. server, device, snapshot, volume, security group, user, buckets, local network or cloud system) information can be organized in a logical fashion in the console.

FIG. 26C, FIG. 26D and FIG. 26E are screen shots of how files can be organized in accordance with the apparatus and method disclosed herein.

FIG. 27 is a single instance view with multiple services of the manner in which files may be organized in accordance with the apparatus and method disclosed herein.

A component or a feature that is common to more than one drawing is indicated with the same reference number in each of the drawings.

### DESCRIPTION OF THE EMBODIMENTS

The present embodiments provide a task management tool for heterogeneous computing environment of systems having Windows and non-Windows operating systems, referred to herein as a CLOUD MANAGEMENT CONSOLE™ (Cloud Management Console is a trademark of Basic6, Inc., Westport, Conn. USA). The Cloud Management Console™ leverages the metaphor for services, local user and group management and file system management that was introduced with the Windows operating system. For example, core APIs that are part of the Microsoft .Net Framework are utilized in a novel manner to provide end users experiences that are similar to the user interface that is provided with the standard Windows tools for account management, event log management, and security management. When reference is made herein to Basic6, components, these components may be included in the embodiments disclosed herein.

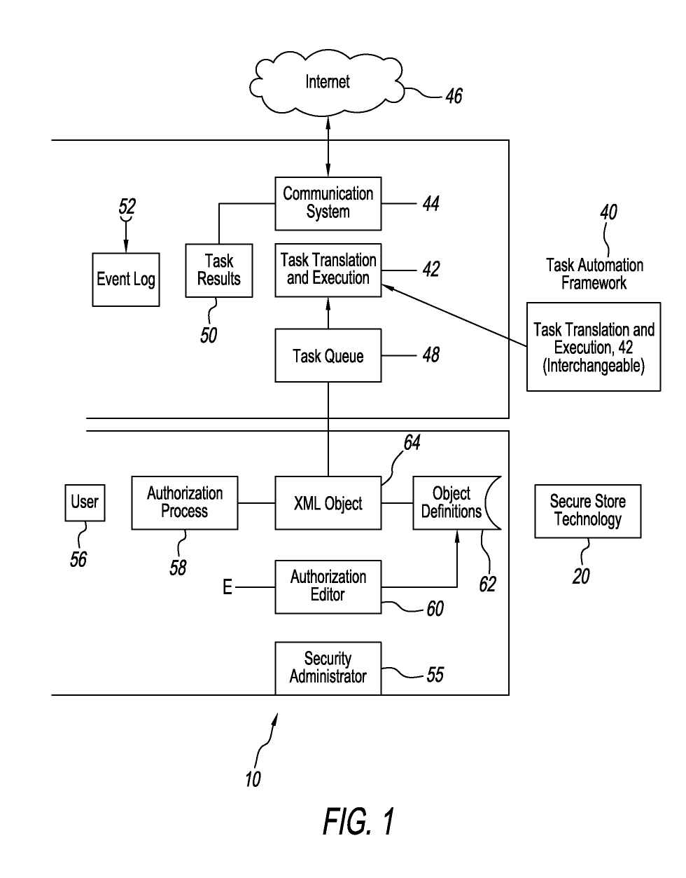

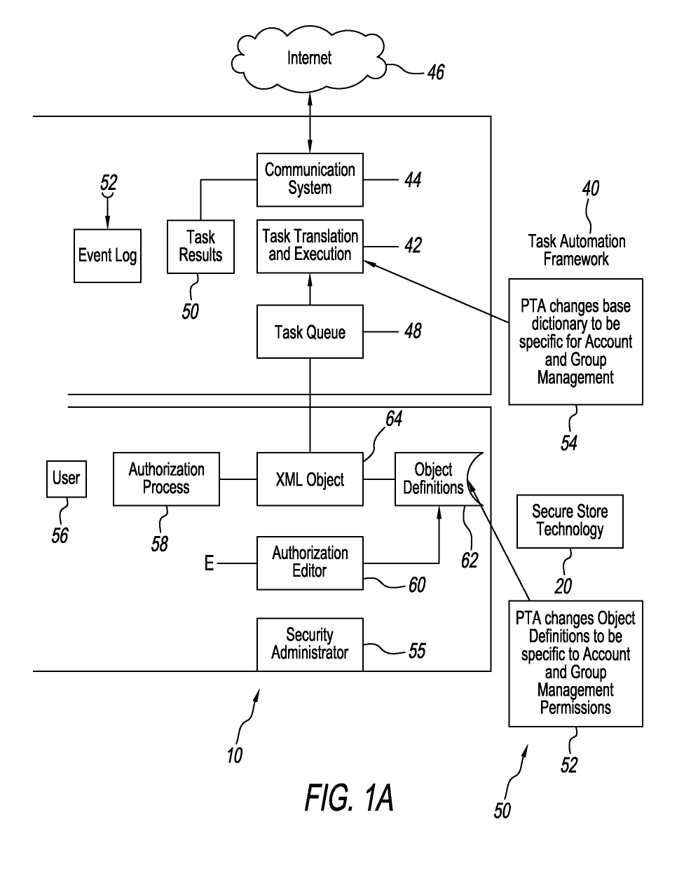

In one embodiment, shown in FIG. 1, the Cloud Management Console™ or console 10 includes two components Secure Store Technology™ (SST), shown generally at 20, and a Task Automation Framework™, shown generally at 40. SST 20 is a merger of technologies used for the management of non-Windows and Windows operating systems from a Microsoft Windows-based desktop. SST 20 merges the Secure Shell or SSH network protocol, Microsoft Management Console API, Microsoft Audit and Event Log API and the Microsoft Windows Security API to form a platform for management of non-Windows and Windows systems that supports the .NET Framework. For example, SST is a Windows based file system that is integrated to administrative tasks for controlling and managing non-Windows and Windows based systems in a remote fashion. As should be appreciated, novelty of the Cloud Management Console™, as described herein, lies in part in the integration of the SSH network protocol, the Microsoft Management Console API, and the Windows Security Sub System for securely performing remote task automation of non-Windows based systems.

Console 10, at a high level, includes a communications system 44 for communicating with the Internet 46, a task queue 48, storage for task results 50, and an event log 52. Also included is a security administrator 55. User data is stored at 56. An authorization process 58 and an authorization editor 60, by way of object definition 62, define XML objects at 64, which are entered into the task queue 48.

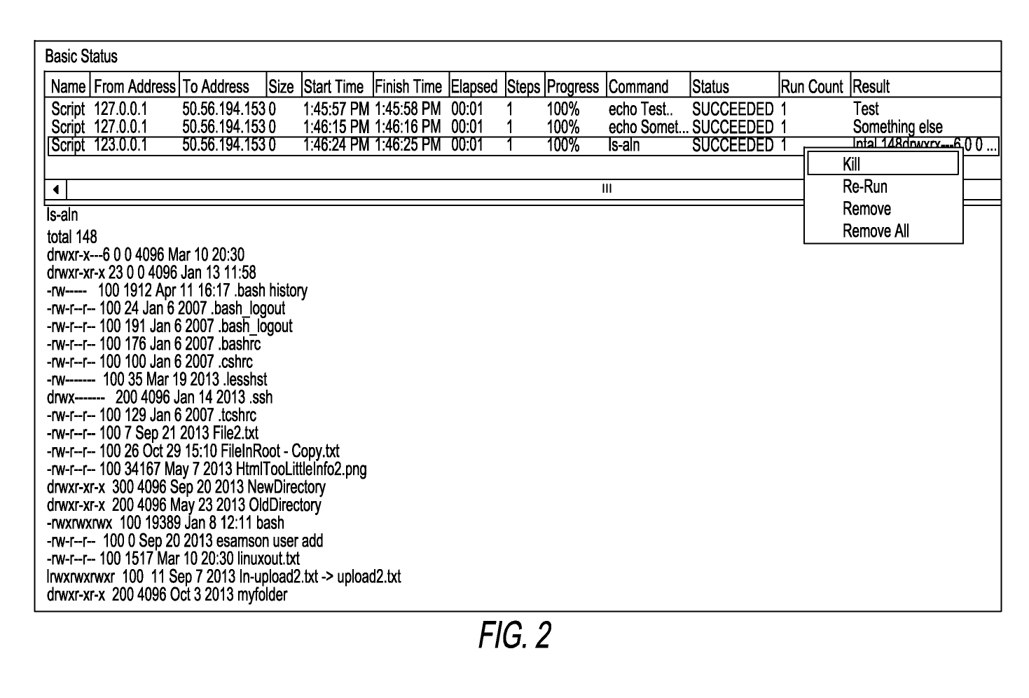

The Task Automation Framework™ 40 includes an intelligent queue controller that leverages the Windows thread pool for simultaneous command execution. As part of the Task Automation Framework™ 40, an intelligent command translator is provided that has the knowledge to translate a task to be executed remotely on the supported operating system. For example, on a host that is running Red Hat Enterprise Linux the command to list users in an enterprise fashion would be “getent—password”. On a host that is running HP/UX the equivalent command would be “hpent—password.” A system administrator manages the Task Execution Framework™ 40 via a process manager 60, an exemplary embodiment of which is depicted in FIG. 2.

Referring again to FIG. 1, in accordance with one aspect of the present invention a Task Translation and Execution portion 42 is provide within the Task Automation Framework™ 40. In accordance with the present invention, the Task Translation and Execution portion 42 of the Task Automation Framework™ 40 is interchangeable to provide various functionality. For example, in a first implementation, functionality to manage user and group accounts in non-Windows and Windows portions of the computing environment is included in the Task Translation and Execution portion 42 to realize a Cloud Management Administrator (CMA). In one embodiment, the Cloud Management Administrator is an agent-less solution that runs on Microsoft Windows operating system for managing and reporting of Accounts and Groups that reside on non-Windows or Windows portions of the heterogeneous computing environment. As described below, the Cloud Management Administrator is the one of a number of solutions offered in a suite of products that leverage the Cloud Management Console for task automation.

As shown in FIG. 1A, the Cloud Management Administrator (CMA), shown generally at 50, integrates into the Cloud Management Console™ 10 in the following manner. In one embodiment, SST Integration is realized as the Cloud Management Administrator 50 introduces permissions 52 specific to the management of accounts, groups and reporting. The management of those new permissions is performed by SST 20. In one embodiment, the Cloud Management Administrator 50 integrates with the Task Automation Framework™ 40 by updating the Task Translation and Execution portion 42 with a dictionary of commands 54 specific to performing account and group management on non-Windows and Windows systems.

References to account and group management are only examples of the types of tasks carried out by the system, but do represent all possibilities. As noted above, other optional and/or additional functionality may be inserted in the Task Translation and Execution portion 42 of the Task Automation Framework™ 40 to provide, for example:
Certificates Management
Computer Management
Device Manager
Disk Defragmenter
Disk Management
Syslog Management
IP Security Monitor
Performance Logs and Alerts
Removable Storage
Security Configuration and Analysis
Process Management
Power Management
Management of hardware on the same device but external to the microprocessor and its associated memory, including WiFi chips, microcontrollers, and BlueTooth emitters.

Some of the advantages of the Cloud Management Console™ or console 10 include:

1. Eliminate the need for a SSH terminal window. The console 10 leverages the existing SSH infrastructure and makes it more secure by reducing and in some cases eliminating the need for a SSH terminal.

2. Increase Security. Guarantee that a connected user can only run the tasks specific to the user. The console 10 guarantees that the user cannot “browse the box.”

3. Increase Administrator Efficiency. An ordinary user who has been granted administrative rights in the console 10 can develop a hierarchy in the Management Console consisting of folders and computers. The creation of the hierarchy is done by simply dragging and dropping objects, and assets, belonging to objects in that hierarchy (such as computers) can be easily added in a similar manner. For instance, user accounts and other objects can be added to the servers represented in the hierarchy such that depending upon where in the tree the Account object is created, that Account object automatically is added to all the computers in the sub tree in a secured and audited fashion.

4. Integrated Auditing. In the console 10 auditing is tied directly into the Windows Event Log, so for the first time auditors can look at the Windows Event Log and easily see what “user x” has done on UNIX/LINUX/Mac machine y (including a snap shot of the SSH session, depending on settings such as security audit control lists [SACL's]).

5. Leverage Active Directory for authorization. All MMC's within the console 10 are tightly integrated into Microsoft Windows security. That is, the MMC's have an internal discretionary access control list (DACL) as well as a security audit control list (SACL). The console 10 runs on Windows XP and/or Windows 2003 or higher. The machine that the console 10 is installed on does not need to be part of a Microsoft Windows Domain.

6. The console 10 provides control over permissions that define what a user can do relative to account management. So for instance, if “user x” has permissions to reset a password for normal users that doesn't mean that he can reset the password for root (e.g., root password reset is a separate permission).

7. Enhanced Reporting. The console 10 generates “out of the box” reports for Users/Accounts, Groups, Group Membership, Computer configuration and authentication. The built-in report capabilities are extensible and can easily be integrated with Microsoft SQL Server, and Microsoft Excel for customization

8. The console 10 embraces the UNIX/Linux best practices for Account and Group Management. The novel, integrated logic module guarantees that the operating system vendors best practices are followed for management of the non-Windows platforms.

9. Integrated token storage. In the console 10 tokens that are used for connecting to the remote UNIX/Linux host are stored as part of the operating system, in the LSA sub system. The storage location is the same location where Windows operating system stores, for example, a user's PassPort or Hotmail account information.

10. Now, using the console 10, Unix/Linux/Mac Administrators can be guaranteed that the operating system vendors best practices for account administration is followed, including the support for SUDO.

One particular embodiment of SST within the console 10 is provided below.

FIG. 2 illustrates an implementation of a status window that can be used to control processing of queued (future) events, and that displays the resulting output of a selected past action.

Secure Store Technology

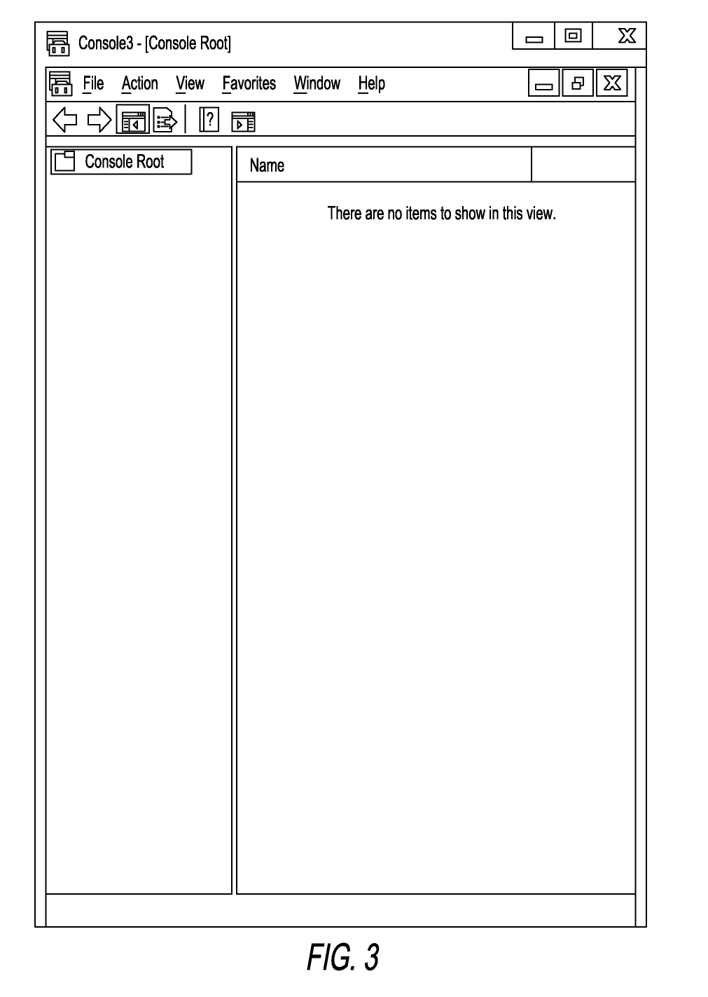

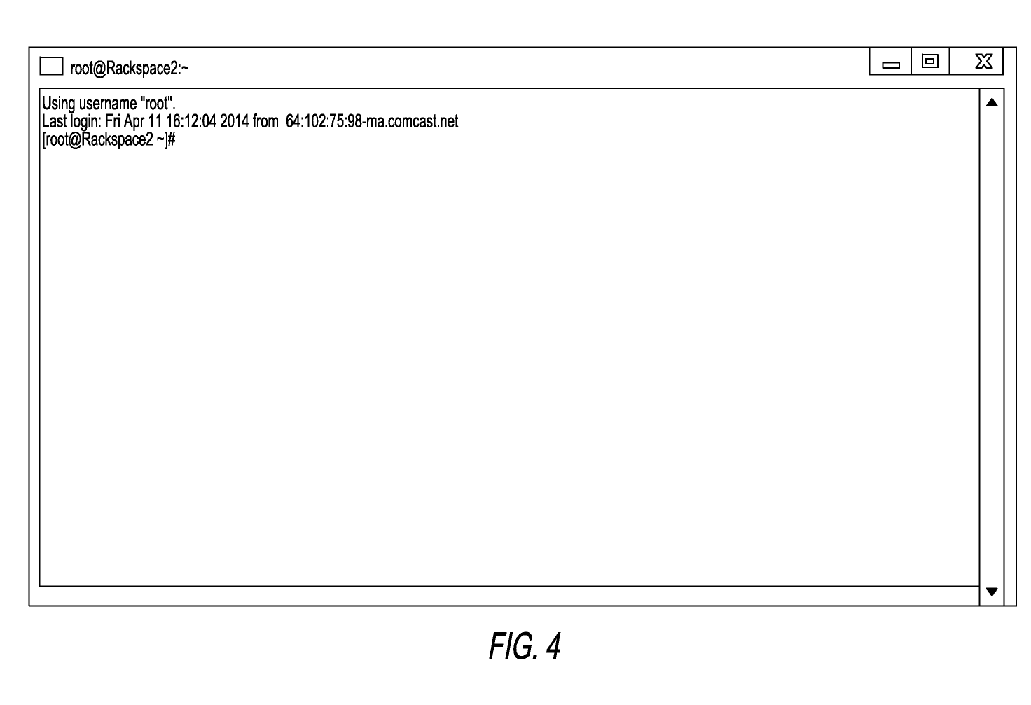

The remote administration of computer systems is commonly performed in one of two ways. In environments where Microsoft Windows Systems are deployed the remote administration of those systems are typically done via the Microsoft Manager Console, as shown in FIG. 3. On systems running non Microsoft operating systems such as UNIX, Linux and Apple Macintosh, administration is typically performed via a terminal console on a separate cloud hoster console, as illustrated in FIG. 4.

Secure Store Technology (SST) as described herein merges the two approaches for management resulting in a new class of management technology.

### DEFINITIONS

Screen Scraping: Originally, screen scraping referred to the practice of reading text data from a computer display terminal's screen. This was generally done by reading the terminal's memory through its auxiliary port, or by connecting the terminal output port of one computer system to an input port on another. As a concrete example of a classic screen scraper, consider a hypothetical legacy system dating from the 1960s—the dawn of computerized data processing. Computer to user interfaces from that era were often simply text-based dumb terminals which were not much more than virtual teleprinters. (Such systems are still in use today[update], for various reasons.) The desire to interface such a system to more modern systems is common. An elegant solution will often require things no longer available, such as source code, system documentation, APIs, and/or programmers with experience in a 45 year old computer system. In such cases, the only feasible solution may be to write a screen scraper which “pretends” to be a user at a terminal. The screen scraper might connect to the legacy system via Telnet, emulate the keystrokes needed to navigate the old user interface, process the resulting display output, extract the desired data, and pass it on to the modern system. In the 1980's financial data providers such as Reuters, Telerate, and Quotron displayed data in 24×80 format intended for a human reader. Users of this data particularly investment banks wrote applications to capture and convert this character data as numeric data for inclusion into calculations for trading decisions without re-keying the data. The common term for this practice, especially in the United Kingdom, was page shredding, since the results could be imagined to have passed through a paper shredder

Microsoft Credential Manager: Since the release of Windows XP in 2001, Windows has included a Credential Management API for managing user credentials. This API is specifically designed to simplify the task of managing user credentials from within applications, as well as to provide a consistent and secure method for associating credentials with your user profile. It can also be used to prompt for credentials that are not persisted, or credentials that your application may persist in an application-specific way, such as by using the Data Protection API.

SECURITY DESCRIPTOR: The SECURITY DESCRIPTOR structure contains the security information associated with an object. Applications use this structure to set and query an object's security status. A security descriptor includes information that specifies the following components of an object's security:

An owner (SID)
A primary group (SID)
A discretionary ACL
A system ACL
Qualifiers for the preceding items

Discretionary Access Control List: An access control list that is controlled by the owner of an object and that specifies the access particular users or groups can have to the object.

System Access Control List: An ACL that controls the generation of audit messages for attempts to access a securable object. The ability to get or set an object's SACL is controlled by a privilege that is set in the Discretionary Access Control List.

SDDL: The security descriptor definition language (SDDL) defines the string format that the ConvertSecurityDescriptorToStringSecurityDescriptor and onvertStringSecurityDescriptorToSecurityDescriptor Windows Authorization API functions use to describe a security descriptor as a text string. The language also defines string elements for describing information in the components of a security descriptor.

Secure Shell: Secure Shell or SSH is a network protocol that allows data to be exchanged using a secure channel between two networked devices. Used primarily on Linux and Unix based systems to access shell accounts, SSH was designed as a replacement for Telnet and other insecure remote shells, which send information, notably passwords, in plaintext, leaving them open for interception. The encryption used by SSH provides confidentiality and integrity of data over an insecure network, such as the Internet.

Security Identifier (SID): A security identifier (SID) is a unique value of variable length that is used to identify a security principal or security group in Windows operating systems. Well-known SIDs are a group of SIDs that identify generic users or generic groups. Their values remain constant across all operating systems.

ACE: Access Control Entry, one of more Access Control Entries make up either a SACL or DACL. Access Control Entries consist of allow and deny flags. Allow flags are cumulative when concatenated in the hierarchy for determining user permissions. Deny flags if set within a hierarchy take precedence and will block the permission from being inherited to the object.

Secure Shell History

In 1995, Tatu Ylonen, a researcher at Helsinki University of Technology, Finland, designed the first version of the protocol (now called SSH-1) prompted by a password-sniffing attack at his university network. The goal of SSH was to replace the earlier rlogin, TELNET and rsh protocols, which did not provide strong authentication or guarantee confidentiality. Ylonen released his implementation as freeware in July 1995, and the tool quickly gained in popularity. Towards the end of 1995, the SSH user base had grown to 20,000 users in fifty countries.

In December 1995, Ylonen founded SSH Communications Security to market and develop SSH. The original version of the SSH software used various pieces of free software, such as GNU libgmp, but later versions released by SSH Secure Communications evolved into increasingly proprietary software.

In 1996, a revised version of the protocol was designed, SSH-2, which is incompatible with SSH-1. SSH-2 features both security and feature improvements over SSH-1. Better security, for example, comes through Diffie-Hellman key exchange and strong integrity checking via message authentication codes. New features of SSH-2 include the ability to run any number of shell sessions over a single SSH connection.

In 1999, developers wanting a free software version to be available went back to the older 1.2.12 release of the original ssh program, which was the last released under an open source license. Bjorn Gronvall's OSSH was subsequently developed from this codebase. Shortly thereafter, OpenBSD developers forked Bjorn's code and did extensive work on it, creating OpenSSH, which shipped with the 2.6 release of OpenBSD. From this version, a “portability” branch was formed to port OpenSSH to other operating systems.

It is estimated that, as of 2000, there were 2,000,000 users of SSH.

As of 2005, OpenSSH is the single most popular ssh implementation, coming by default in a large number of operating systems. OSSH meanwhile has become obsolete.

In 2006, the aforementioned SSH-2 protocol became a proposed Internet standard with the publication by the IETF “secsh” working group of RFCs.

Secure Store Technology Details

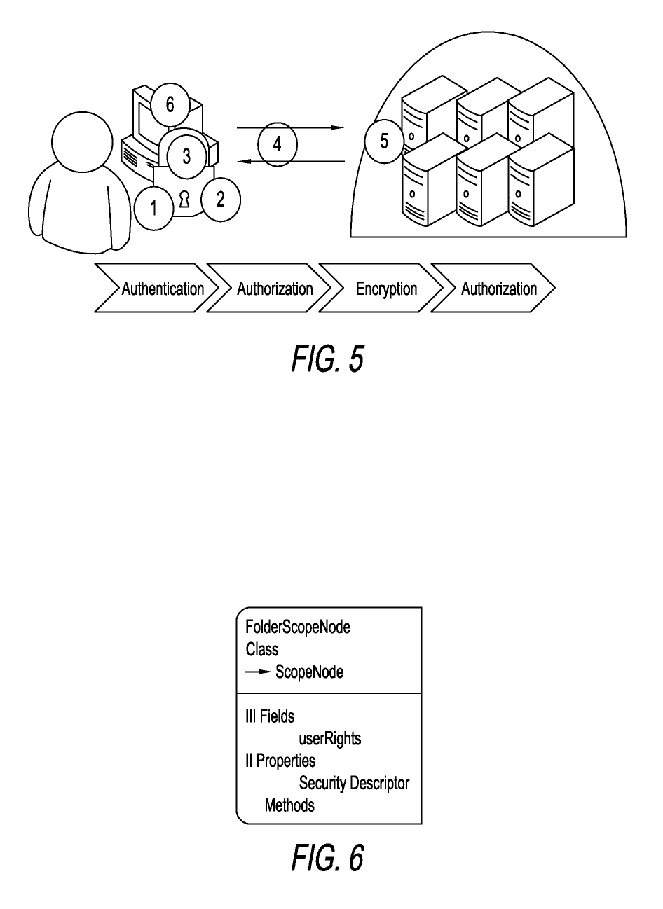

Secure Store Technology, leverages the combination and integration of the SSH protocol, Microsoft Management Console and native windows security. A high level example of SST in order to access a remote UNIX/Linux or Macintosh computer the following steps and checks need to be performed. As shown in FIG. 5, SST addresses the following:

1. User needs to be authenticated by Windows.

2. User needs to be authorized within a Secure Store Enabled Management Console.

3. Credentials for connecting to the remote UNIX/Linux/Macintosh host are looked up within the Windows Credential Manager.

4. SSH connection started and established using stored credentials.

5. Command executed on the remote system.

6. Results of the command are displayed in the Secure Store Enabled Console. The results are screen scraped in the case of the user employing a terminal window to effect changes to the remote server. In other cases (the majority of cases), returns are garnered either from the stdout/stderr data streams or from the return values of API calls.

Security in a SST Console

Microsoft Management Consoles maintain a XML representation of the nodes that are configured within the console the nodes and the data that are part of the SST implementation are persisted to disk in a binary form.

When a SST enabled console is open, SST derives its nodes from the scope node class, that is part of the Microsoft Management Console Name Space which is part of the Microsoft .net framework. In accordance with the present disclosure, each node contains its own security descriptor, which gets persisted as a string.

SST Name Space

Management consoles by default do not have object ace's so as part of the SST implementation a proprietary Name Space is provided for associating aces to objects and for defining objects.

Definition of an object and the ACE's associated with an object are defined in an XML based Object Definition Language.

Objects

Cloud Management Administrator can have the following objects predefined; note that the Guids are subject to change:

TABLE I

| Object Name | Object Guid |
|---|---|
| folderObjectId | {5B7607F7-D120-47f4-A2C1- |
| | 3C52DAAF9E84} |
| hostObjectId | {9333F374-54BA-46f2-A763- |
| | 80FE890000B4} |
| accountObjectId | {OEED8968-C4A1-435b-9EB5- |
| | 3483F7F08D21} |
| groupSecurityObjectId | {38DA2B4A-C442-4dea-91C9- |
| | 058EF13886C9} |
| groupMemberSecurityObjectId | {CBFA29EB-6DBF-471d-9F40- |
| | 364A2AC5ABDD} |
| miscellanousObjectId | {5492727F-BFE4-409e-9855- |
| | F8DCFFE82729} |
| passwordObjectId | {786F61F1-EEF5-4a91-B706- |
| | A419C055C7FB} |
| processObjectId | {4C248FDF-5608-4088-83D7- |
| | 087D5F57303C} |
| reportObjectId { | A2D8D616-9E8E-47a8-823A- |
| | A79125290B59} |
| securityAdminObjectId | {68399F91-80A6-4930-990A- |
| | 71272CD27485} |
| terminalObjectId | {03240D58-C302-4d54-BED9- |
| | B3F85DC885D3} |

Each object can have a variable length of rights. Rights get translated into object ACE's.

Object Definition

Objects in a SST enabled console have security properties. The security property formal name, is that of a Security Descriptor or SD. All SD's are inherited from the node's parent Node in an additive manner FIG. 6 depicts one embodiment of the node security.

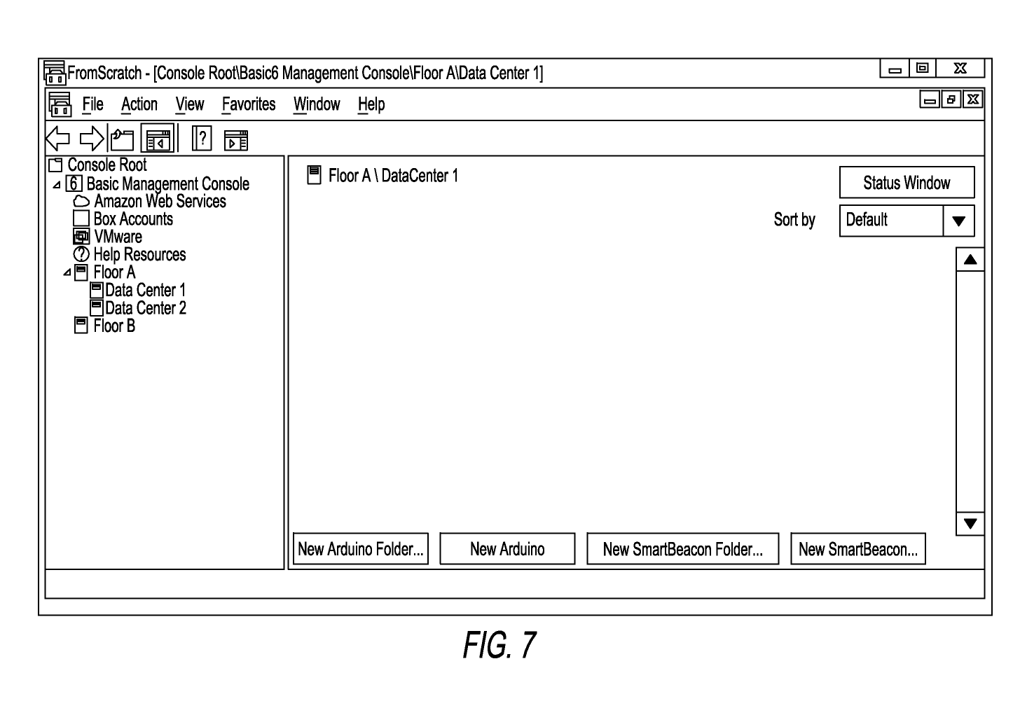

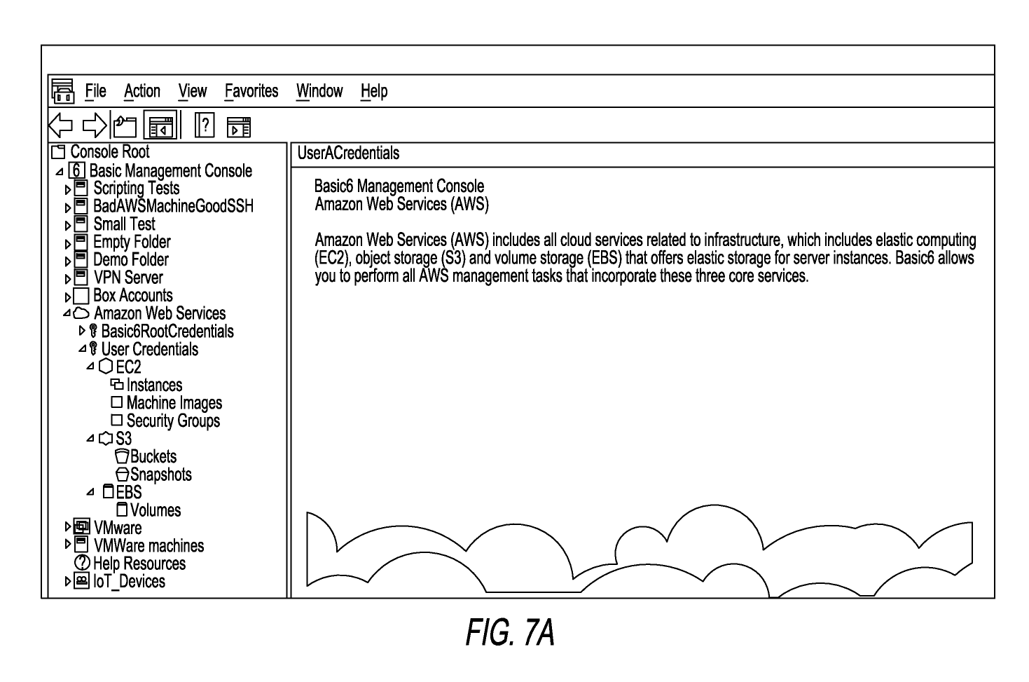

FIG. 7 depicts an example of node inheritance as it applies to networked servers. In FIG. 7 Application Inheritance, Folder Number 1 inherits security settings from the following folders in an additive fashion:

### 1. Floor A

### 2. Data Center 1

FIG. 7A depicts an example of node inheritance as it applies to cloud service assets. In the case of a Cloud service, credentials to access the API of the corresponding service, stored in the Windows Credentials Manager, apply to all objects derived from the structure visually placed in subfolders of nodes representing the ancestral service/credentials node.

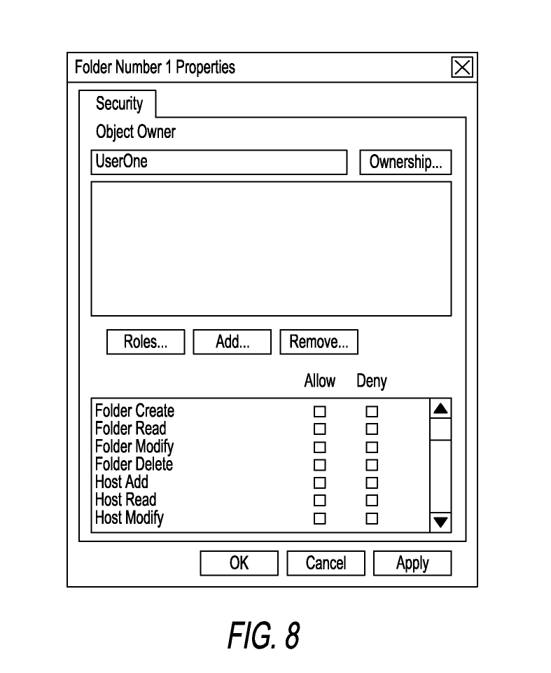

FIG. 8 is an illustration of a user interface where security settings may be applied to a node. The settings applied to an object are inherited as described below.

Object Inheritance

Both the DACL and SACL are inherited from the parent of an object. Each DACL and SACL includes SST ACES that can either concatenate a right or block a right being applied to the object. Editing of an object's SD and its DACL and SACL is done via the Access Control Editor, which is part of a objects base security.

Authorization in a SST Enabled Console

When an SST enabled console is open, the logged on user's credentials are validated against the DACL that is contained within the persisted SD for authorization to perform the specific task.

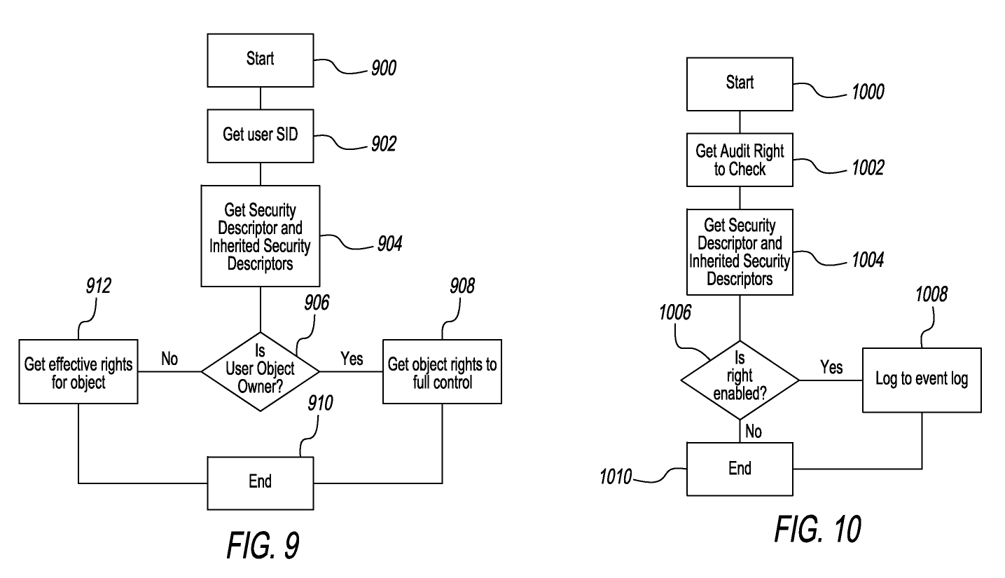

FIG. 9 illustrates authorization flow for objects in the SST enabled console. At 900 the process starts. At 902, user SID is obtained. At 904, s security descriptor and inherited security descriptors are obtained. At 906, an inquiry is made as to whether the user is the owner of the object. If the answer is Yes, at 908 object rights are set to full control. At 910, the process ends. If at 906, the answer is No, at 912, effective rights are obtained for the object. Again, at 910, the process ends.

Audit in a SST Enabled Console

As shown in FIG. 10, auditing of objects within an SST enabled console is based on the rights set within an object's SACL. At 1000, the process starts. At 1002, audit rights are made available for checking. At 1004, the security descriptor and inherited security descriptors are obtained. At 1006, if the rights are turned on for the SACL, then events are generated to be logged to the event log, at 1008. The flow ends at 1010. If at 1006, the rights are not turned on, flow ends at 1010.

Windows Audit Log and SACL Rights

Should the SACL right be set for the object or method an entry within the Windows event log showing the audited event and description text is recorded. Part of the recording includes the user's SID, which when displayed shows the user's display which is stored either in the operating systems SAM or coming from Windows Active Directory the application natively calls the ReportEvent api.

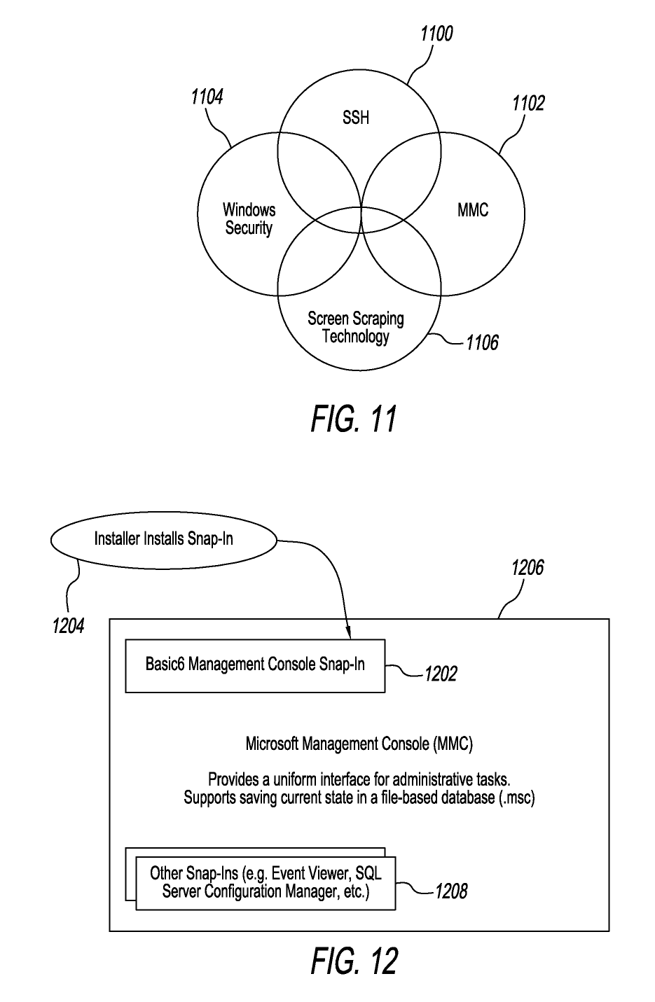

As shown in FIG. 11, SST is the merger of technologies used for management of non-Microsoft systems from a Microsoft desktop. SST merges the SSH protocol 1100, Microsoft Management Console API 1102, Microsoft Audit and Event log API (not shown in FIG. 11) and the Microsoft Windows Security API's, as well as screen scraping technology 1106, to form a new platform for management of non-Microsoft form systems that support the Microsoft .NET Framework.

SST can be thought of as a new Windows based file system, that is tightly integrated to administrative tasks for controlling and managing non Microsoft based systems in a remote fashion.

While Microsoft has made the API for creating management consoles public, there is no company or product that exists today that has integrated the MMC API, the SSH protocol and the Windows Security Sub System for securely performing remote task automation of non-Microsoft systems in the data center and the cloud.

Referring to FIG. 12, in a preferred embodiment, the apparatus and method disclosed herein can be implemented by a snap-in software component 1202 that is installed 1204 in a Microsoft Management Console (MMC) 1206. Other snap-ins 1208 may include an event viewer, and an SQL Server configuration manager, and others well known in the art. When installation is complete, a desktop icon is provided, that when clicked, opens a pre-configured (Basic6 snap-in) MMC console, as discussed below.

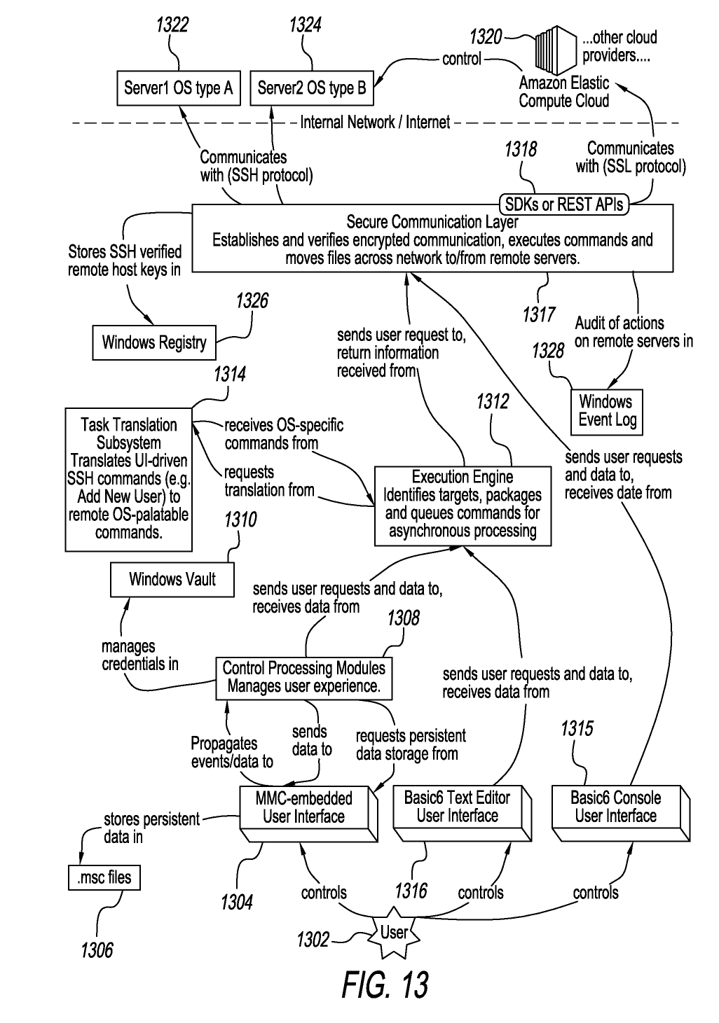

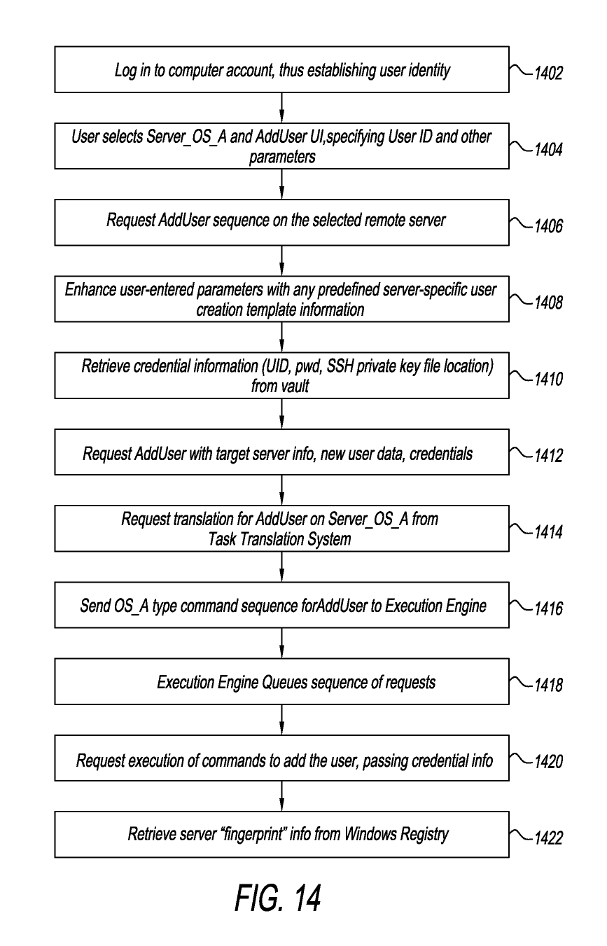

Referring to FIG. 13, and FIG. 14, a user 1302 logs into a computer account, thus establishing a user identity at 1402. The user does so with an MMC-embedded User Interface 1304 which saves and stores user configurations/paths (remote servers, connection to AWS) as .msc files in a persistent data file storage area 1306. The .msc files can be re-opened and shared amongst multiple users. A logged on Windows ID is required for Single Sign on (SSO) access to the end user desktop/server on which the .msc file is opened.

At 1404, a user who has logged in selects a server having a particular operating system and adds his user ID and specifies other parameters. At 1406, the user requests that an add user sequence is started on the selected remote server, and at 1408, user entered parameters are enhanced with any predefined server-specific user creation template information. This is done with the Control Processing Modules 1308 which manage the user experience by enabling the access and marriage of the MMC (saved servers) and the Windows Vault 1310, which is used as the credential repository for server access. In other words the saved MMC (.msc file) provides cached server connectivity information (DNS, IP address) with the Windows Vault 1310 acting as the store for credentials which allow for the access to this information. Thus, at 1410, credential information (UID, pwd, SSH private key file location) is retrieved from vault 1310.

Once access has been granted to a remote server in either a data center or in the cloud action requests are sent to an Execution Engine 1312, which under the covers identifies the target, packages and queues the console commands for asynchronous processing. All commands flow through a Task Translation Subsystem 1314 that queries the target and identifies the specific native commands that execute versus the OS. The Basic6 Text Editor User Interface 1316, which is processed via Execution Engine 1312, is a Windows based display that normalizes the interchange of eol (end of line) text between Unix, Linux, Mac and Windows. Thus, steps of Requests AddUser with target server info, new user data, credentials at 1412 and Requests translation for AddUser on Server_OS_A from Task Translation System at 1414 are completed.

All command issuance, from a console user interface 1315, follows secure communications protocol. This underlying Secure Communication Layer 1317 is comprised of secure calls to target systems utilizing the SSH protocol (for connection to Internal Network, Internet (External, including non API Cloud) in conjunction with SDKs or Rest APIs 1318, used for connection to the Amazon Elastic Compute Cloud 1320 amongst other cloud providers 1322 and 1324. The secure Windows Registry 1326 is used as the repository for all SSH verified remote host keys for communication with Internal Network, External, and Cloud servers. It is this persistent data storage that is called upon within the Control Processing Modules 1308 connectivity request.

At 1416, an OS_A type command sequence forAddUser is sent to Execution Engine 1312. At 1418, Execution Engine 1312 queues the sequence of requests. At 1420, a request is made for execution of commands to add the user, passing credential information on to the selected server. At 1422, server “fingerprint” information is retrieved from Windows Registry 1326.

All commands issuance by console user interface 1315 are captured within the Windows Event Log 1328. This provides a full audit of actions executed on remote servers replete with native command issuance, executing user information that includes Windows identification and the computer of action issuance.

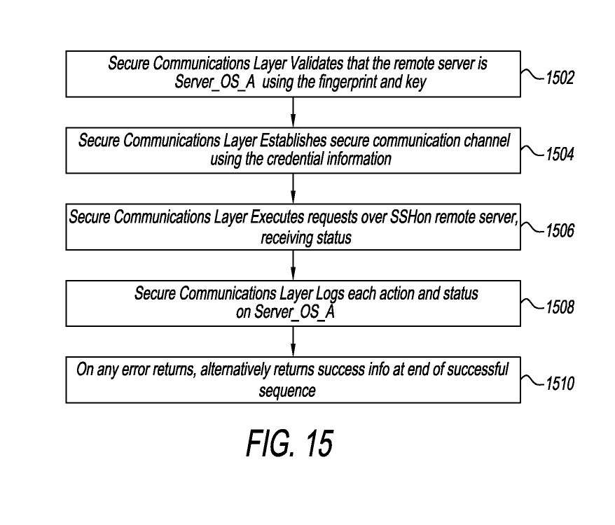

Referring to FIG. 15, at 1502 secure Communications Layer 1317 validates that the remote server is, for example, Server_OS_A using the fingerprint and key. At 1504, Secure Communications Layer 1317 establishes a secure communication channel using the credential information. At 1506, Secure Communications Layer 1317 executes requests over SSH on the remote server, receiving status information. At 1508, Secure Communications Layer 1317 logs to Windows event log 1328, each action and status on the server being accessed. At 1510, any error returns are sent to the execution engine 1312; alternatively success return information is sent to execution engine 1312 at the end of a successful sequence of commands.

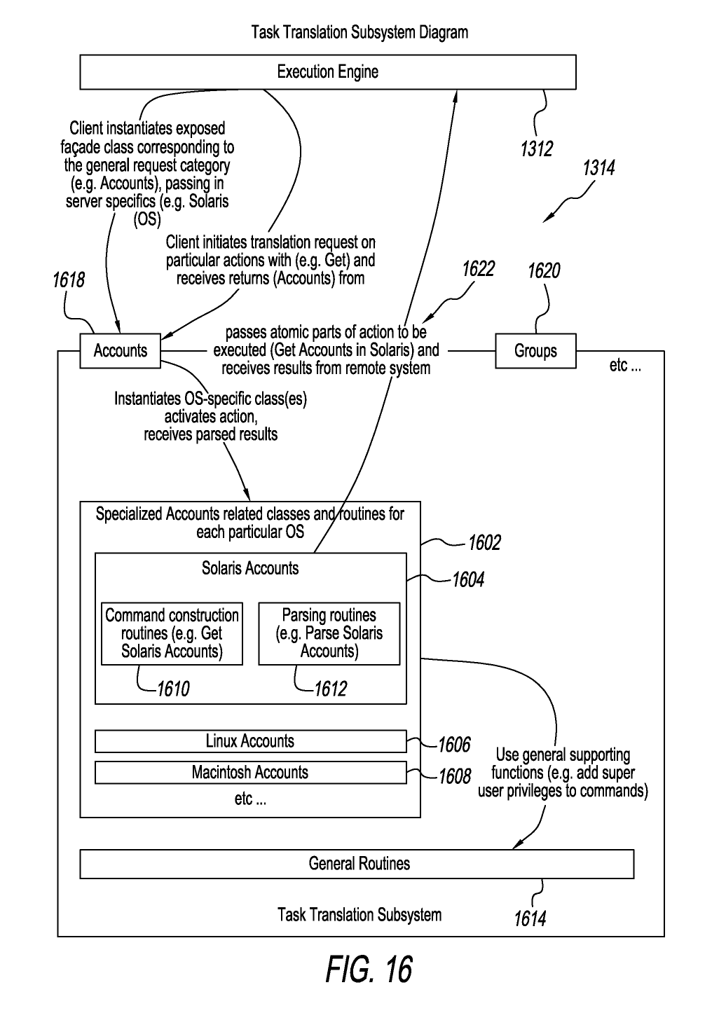

FIG. 16 illustrates the structure and function of the task translation subsystem 1314. Task translation subsystem 1314 accesses specialized account, group and file related classes and routines (with more to be added), including create, delete and edit files, at 1602 for each operating system such as, for example, Solaris 1604, Linix 1606, Macintosh 1608 and many others. Each account will have operating system specific command construction routines 1610 and instruction parsing routines 1612. Specialized account related classes and routines 1602 also has access to general routines 1614 which perform general functionality such as adding security related decorations to commands.

An accounts module 1618 instantiates the operating system for a specific class or classes, activates various actions and receives parsed results. In addition to individual accounts, groups and file system management 1618 initiates the operating system-specific class or classes.

At 1622, task translation subsystem 1314 parses atomic parts of an action to be executed from the account being used. Further, results can be received from a remote system via execution engine 1312. For example the user may instantiate an exposed façade class corresponding to the general request category (e.g. Accounts), in server specifics, such as in the Solaris operating system. The user may also initiate translation requests on particular actions (e.g. Get) and receive returns (Accounts) from the remote system via execution engine 1312.

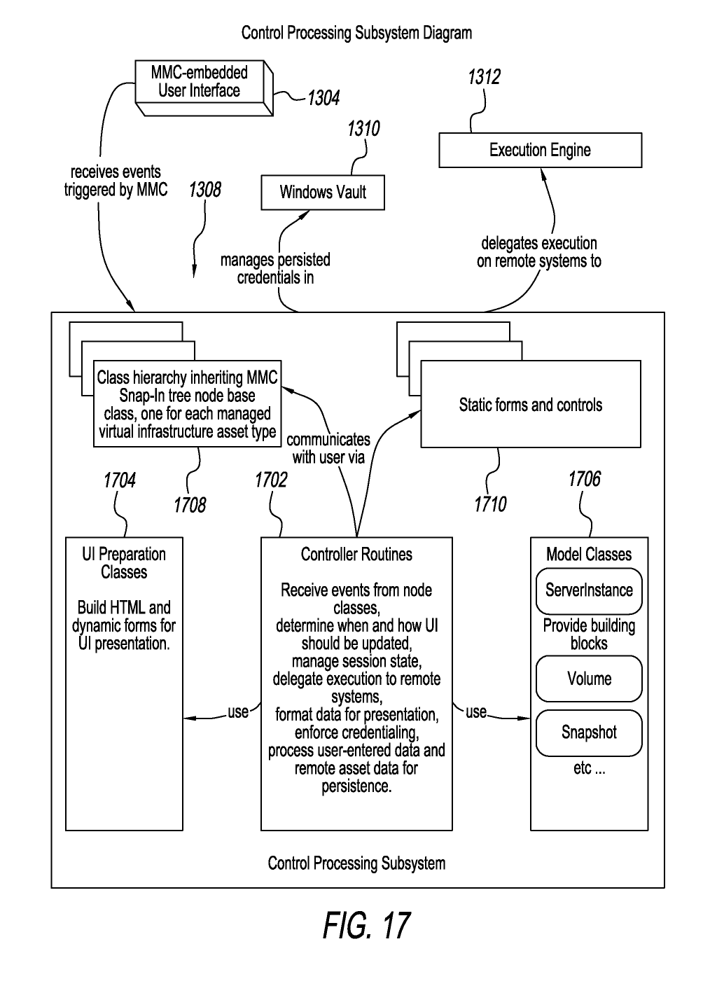

FIG. 17 illustrates the structure and function of the control processing subsystem 1308. Control processing subsystem 1308 receives events triggered by the MMC embedded user interface 1304 and manages persistent credentials in Windows vault 1310. Controller routines 1702 in control processing subsystem 1308 receive events from node classes, determine when and how the user interface should be updated, manage session state, delegate execution two remote systems, format data for presentation, force credentialing, process user entered data and remote asset data for persistence. Control processing subsystem 1308 delegates execution on remote systems to execution engine 1312.

Controller routines 1702 use user interface preparation classes 1704 to build HTML and dynamic forms for user interface presentation. Controller routines 1702 also use model classes 1706 to provide building blocks for each server instance storage volume Snapshot and other functions. Controller routines 1702 communicates with the user via a class hierarchy 1708 which inherits MMC snap-in tree node base classes (one for each manage virtual infrastructure asset type). Communication is also accomplished via static forms and controls 1710.

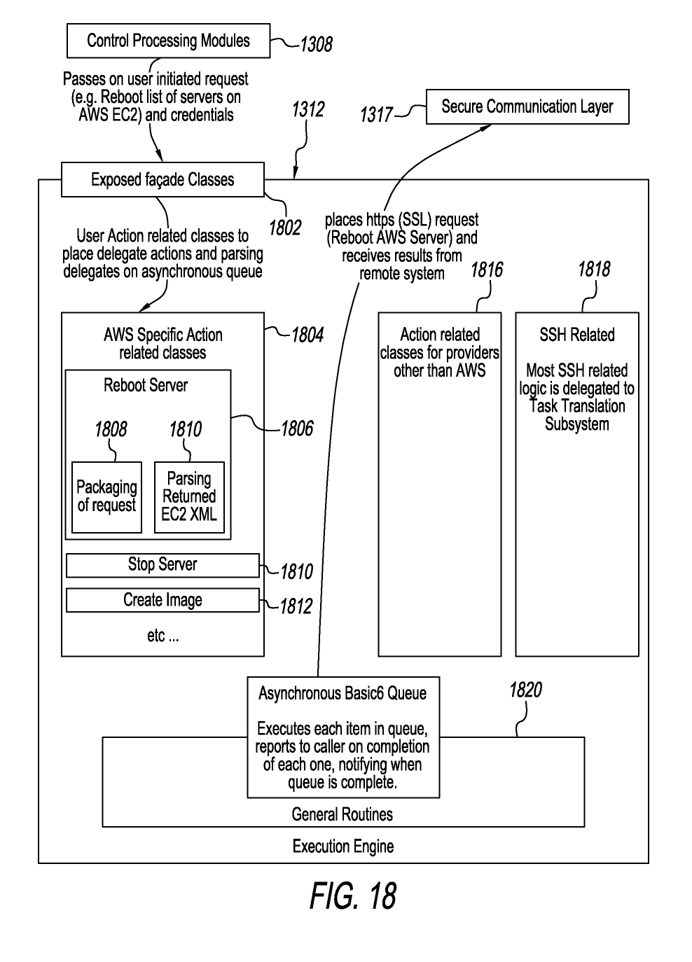

Referring to FIG. 18, the execution engine subsystem 1312 receives user initiated requests from control processing modules 1308. These requests can include the rebooting of a list of servers associated with Amazon Web Services (AWS) elastic compute cloud (E2C) and appropriate credentials. This information is passed to exposed façade classes 1802. Action related classes are used to place delegated actions and parsing on an asynchronous queue. AWS specific action related classes includes reboot of a server 1806. Routines are available for packaging of a request 1808 and for parsing returned EC XML commands 1810. Other classes include stop server 1812 and create image 1814, as well as numerous others.

Action related classes for providers other than AWS are available in 1816. While most SSH related logic is delegated to task translation subsystem 1314, any additional SSH related logic is found at 1818. General routines 1820 deal with the asynchronous queue. Specifically, each item in the queue is executed, reports are sent to the caller on completion of each item, and the caller is notified when all commands in the queue have been completed. These commands can include placing https (SSL) requests such as rebooting of the AWS server. Results from the remote server can be received.

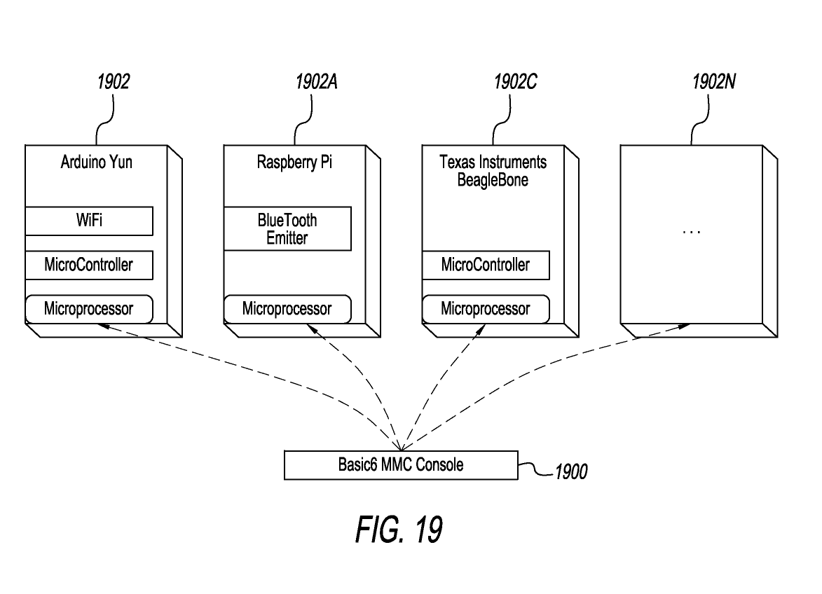

In FIG. 19 control can be exercised on devices on a local network by a desktop console 1900, or for any internet-connected device via the cloud platform. Such devices include the Yun device 1902, Raspberry Pi device 1902A, Texas Instruments MSP430 1902C, and any other device including up to device 1902N. Control can also be exercised of hardware peripheral to the microprocessor, such as microcontrollers, WiFi chips, and BlueTooth emitters.

In FIG. 19, on the devices that contain an MCU, instead of relying on a program running on the MCU, the functionality of which is extended by the Linino for computing power and communication, monitoring and control is delivered by the secure execution of scripts from the Basic6 Console, without the use of agents.

This mechanism is in the case of devices containing an MCU designed to leave the entire application programming unburdened by any intrusion into the MCU by Basic6 control, and can operate completely independent of it. However, control over the MCU by Basic6 allows the restart, stopping, starting of the MCU itself, as well as replacement of the application program running on the MCU.

In the case of non-MCU peripherals, such as WiFi and BlueTooth emitters, control is similar in delivery to the MCU case.

The Basic6 console achieves uniform application of controls against heterogeneous device types but with similar peripheral hardware (eg. varieties of Bluetooth emitters on different device types) to simplify the process whereby such hardware is controlled.

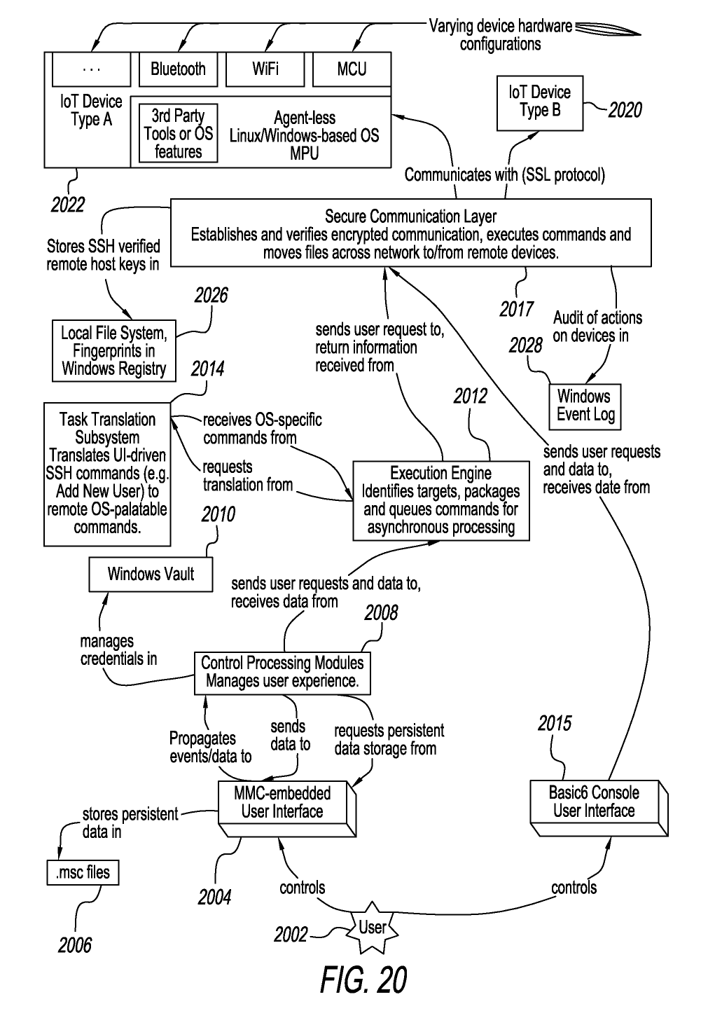

FIG. 20 provides an overview of the operation of the desktop tool. Requests for control and data are in this context always initiated from the desktop tool side. This is because the system here is “agent-less”, which significantly reduces the need for prior device configuration and registration during deployment. Features of the operating system are used to manage the devices, and sometimes third party open-source tools dedicated to these purposes, such as AvrDude that can be used to stop/start or change the programming on the MCU residing on an Arduino Yun device. Such tools are typically included in the distribution of the device out of the box, but when that is not the case, they would need to be installed on the device prior to use with Basic6; this is the only setup required, beyond ensuring that communication is possible with the MCP of the device.

In FIG. 20, a user 2002 logs into a computer account, thus establishing a user identity. The user does so with an MMC-embedded User Interface 2004 which saves and stores user configurations/paths to devices as .msc files in a persistent data file storage area 2006. The .msc files can be re-opened and shared amongst multiple users. A logged on Windows ID is required for Single Sign on (SSO) access to the end user desktop/server on which the .msc file is opened.

A user who has logged in selects a device having a particular operating system and adds his user ID and specifies other parameters. The user requests action to be started to control or monitor the selected remote device, or to manage the contents of the operating system itself. The user entered parameters are enhanced with any predefined device specific user creation template information. This is done with the Control Processing Modules 2008 which manage the user experience by enabling the access and marriage of the MMC (saved devices) and the Windows Vault 2010, which is used as the credential repository for device access. In other words the saved MMC (.msc file) provides cached device connectivity information (DNS, IP address) with the Windows Vault 2010 acting as the store for credentials which allow for the access to this information. Credential information (UID, pwd, SSH private key file location) is retrieved from vault 2010.

Once access has been granted to a remote device in either a data center or in the cloud, action requests are sent to an Execution Engine 2012, which under the covers identifies the target, packages and queues the console commands for asynchronous processing. All commands flow through a Task Translation Subsystem 2014 that queries the target and identifies the specific native commands that execute versus the OS.

All command issuance, from console user interface 2015, follows secure communications protocol. This underlying Secure Communication Layer 2017 is comprised of secure calls to target systems utilizing the SSH protocol (for connection to Internal Network, Internet (External, including non API Cloud) in conjunction with SDKs, used for connection to agent-less devices 2022 and 2020, of heterogeneous types. The secure Windows Registry 2026 is used as the repository for all SSH verified remote host finger prints, and the file system for the keys themselves, for communication with Internal Network, External, and Cloud servers. It is this persistent data storage that is called upon within the Control Processing Modules 1008 connectivity request.

Execution engine 2012 queues the sequence of requests. Device “fingerprint” information is retrieved from Windows Registry 2026.

All commands issuance by console user interface 2015 are captured within the Windows Event Log 2028. This provides a full audit of actions executed on remote devices replete with native command issuance, executing user information that includes Windows identification and the computer of action issuance.

Task Translation Subsystem

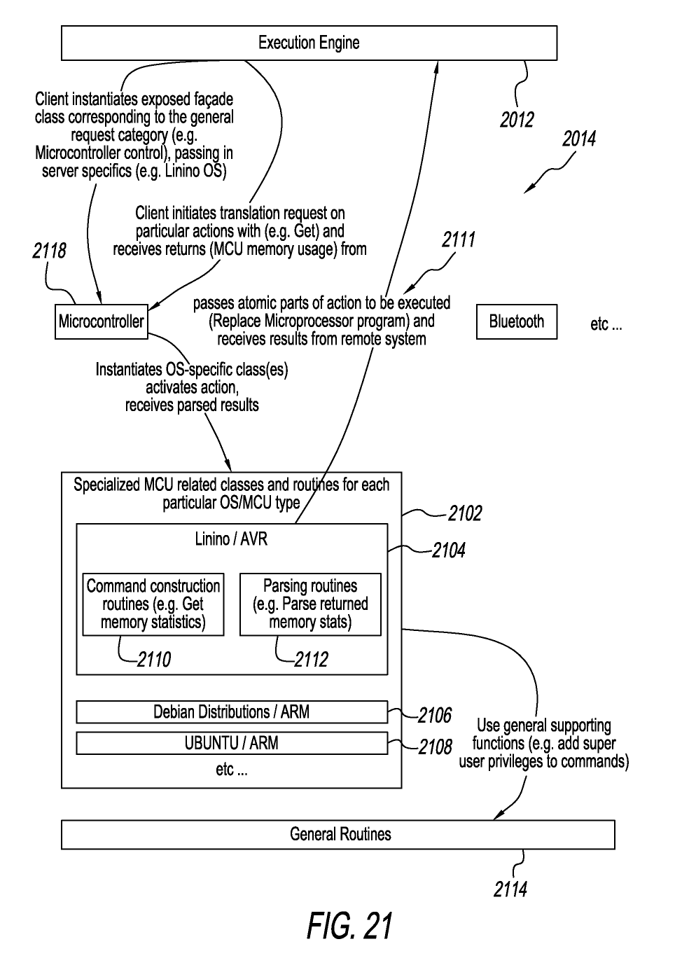

FIG. 21 illustrates the structure and function of the task translation subsystem 2014 for abstracting these variations away so that device control can be presented in a uniform manner. Here, the particular operating system (e.g. Linino) that the desktop connects to requires particular commands to manage the particular type of hardware aspect (e.g. an MCU of the AVR variety) within the same device.

In FIG. 21 task translation subsystem 2014 accesses specialized account, group and file related classes and routines (with more to be added), including create, delete and edit files, reboot the system, control associated hardware such as a Bluetooth emitter with stop/start/reconfigure UUID commands, or a microcontroller with stop/start/restart/update program commands, at 2102 for each operating system such as, for example, Linino/AVR 2104, Debian Distributions/ARM 2106, UBUNTU 2108 and many others. Each account will have operating system specific command construction routines 2110 and instruction parsing routines 2112. Specialized account related classes and routines 2102 also has access to general routines 2114 which perform general functionality such as adding security related decorations to commands.

A microcontroller 2118 instantiates the operating system for a specific class or classes, activates various actions and receives parsed results. In addition to individual accounts, groups and file system management microcontroller 2118 initiates the operating system-specific class or classes.

At 2122, task translation subsystem 2014 (FIG. 20) parses atomic parts of an action to be executed from the account being used. Further, results can be received from a remote system via execution engine 2112. For example the user may instantiate an exposed façade class corresponding to the general request category (e.g. Stop MCU), in server specifics, such as in the Solaris operating system. The user may also initiate translation requests on particular actions (e.g. Get) and receive returns (Action responses) from the remote system via execution engine 2012.

Control Processing Modules

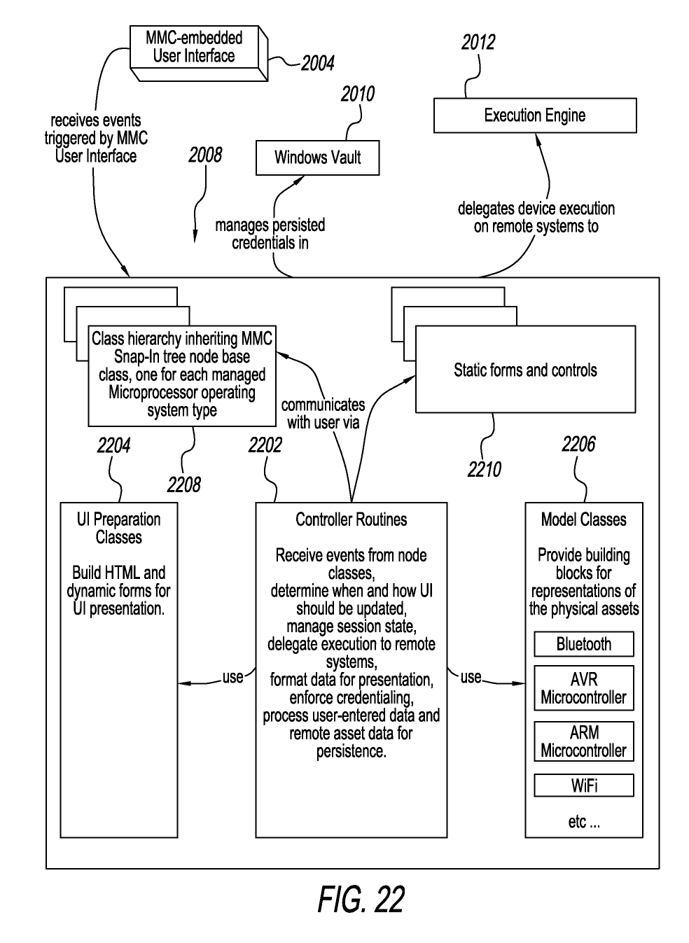

FIG. 22 demonstrates how, with Control Processing Modules 2008 (FIG. 20), the user experience is managed, allowing devices with heterogeneous operating systems and differing physical device configurations to be managed side-by-side, and have operations performed in bulk. An example, is replacing the current programs running on multiple Arduino Yun and Arduino Tre devices with an upgrade of their software.

Thus, FIG. 22 illustrates the structure and function of the control processing subsystem 2008. Control processing subsystem 2008 receives events triggered by the MMC embedded user interface 2004 and manages persistent credentials in Windows vault 2010. Controller routines 2202 in control processing subsystem 2008 receive events from node classes, determine when and how the user interface should be updated, manage session state, delegate execution two remote systems, format data for presentation, force credentialing, process user entered data and remote asset data for persistence. Control processing subsystem 2008 delegates execution on remote systems to execution engine 2012.

Controller routines 2202 use user interface preparation classes 2204 to build HTML and dynamic forms for user interface presentation. Controller routines 2202 also use model classes 2206 to provide building blocks for each device instance physical assets such as Bluetooth emitter, MCU, WiFi chip, and other functions. Controller routines 2202 communicate with the user via a class hierarchy 2208 which inherits MMC snap-in tree node base classes (one for each managed virtual infrastructure asset type). Communication is also accomplished via static forms and controls 2210.

Execution Engine

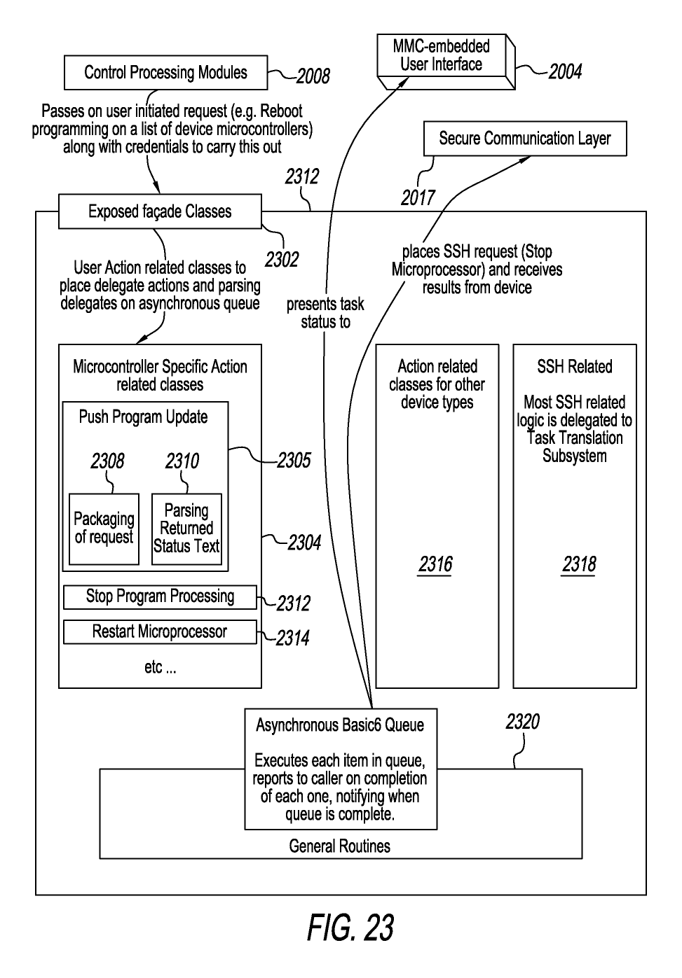

In FIG. 23, the inner workings of the execution engine 2012 (FIG. 20) are shown. The types of targets are identified, placed on a queue for asynchronous processing, and reports are made to the user interface.

Referring to FIG. 23, the execution engine subsystem 2312 receives user initiated requests from control processing modules 2008. These requests can include the rebooting of a list of devices as set forth herein. This information is passed to exposed façade classes 2302. Action related classes are used to place delegated actions and parsing on an asynchronous queue. Microcontroller specific action related classes are available at 2304. Program updates that can be pushed to devices are available at 2305. Packaging of a request is done at 2308. Parsing of returned status text is accomplished at 2310. Device type specific action related classes include stopping program processing at 2312 and reboot of the microprocessor at 2314. Routines are available for packaging of a request 2308 and for parsing returned information 2310. Other classes include stop server 2312 and create image 2314, as well as numerous others.

Action related classes for device types other than microcontrollers are available in 2316. While most SSH related logic is delegated to task translation subsystem 2014, any additional SSH related logic is found at 2318. General routines 2320 deal with the asynchronous queue. Specifically, each item in the queue is executed, reports are sent to the caller on completion of each item, and the caller is notified when all commands in the queue have been completed. These commands can include placing requests such as rebooting of the device. Results from the remote device can be received.

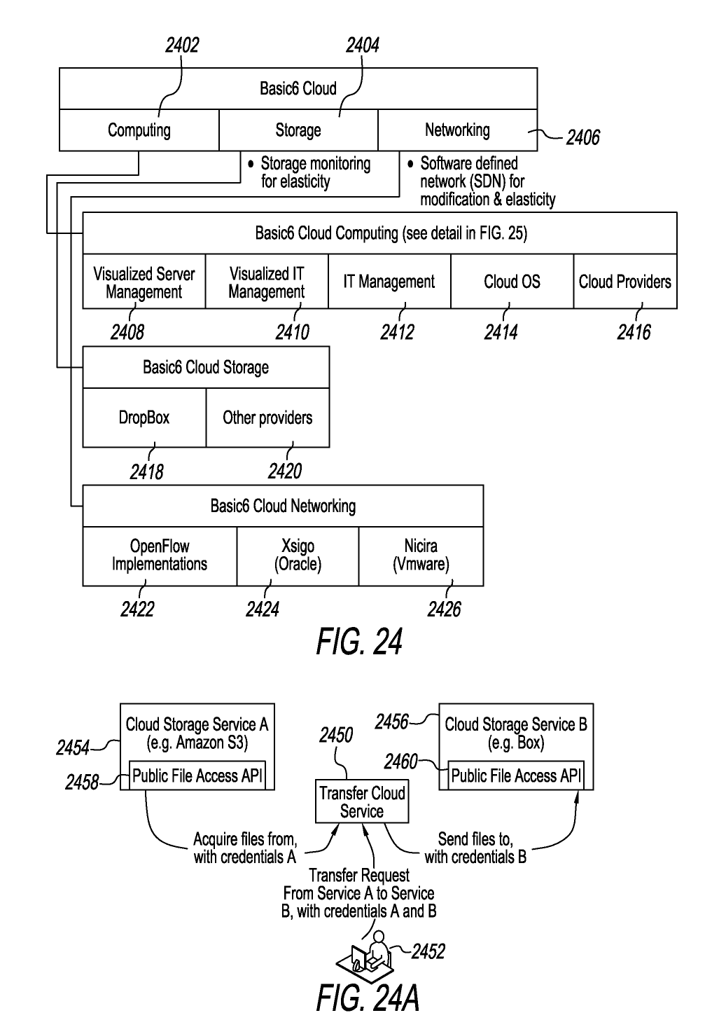

Referring to FIG. 24 a general overview of what has been disclosed is illustrated, and the manner in which it is positioned with respect to providers of services, many of which reside in the cloud. FIG. 24 also illustrates the manner in which the embodiments disclosed herein are directed to a cloud-based offering that collect and oversees computing 2402, storage 2404 and networking 2406, under one umbrella. With respect to computing the disclosed system and methods provide visualized server management 2408, visualized IT management 2410, IT management 2412, interaction with various cloud operating systems 2414 and cloud providers 2416. Storage can include Dropbox 2418 and other providers 2018. Networking can include open flow implementations 2422, Xsigo (an Oracle product) 2424 and Nicira (Vmware) 2426.

FIG. 24A is a flow diagram of cloud data and file transfer service, or transfer cloud service 2450, that avoids the difficulties generally associated with data or file transfer discussed above. Transfer cloud service 2450 is preferably hosted outside of the domain of the user 2452. A single request is made by user 2452 for the transfer, after which the files are requested on the user's behalf from the originating service 2454, and the files sent on the user's behalf to the destination service 2456. During an initial sign-up, credentials are provided by the user 2452 to the transfer cloud service 2450 so that it may act on the user's behalf. This is typically carried out using OAuth, the purpose of which is in this case that the transfer cloud service 2450 receives only tokens for access that may be revoked, instead of the user's actual account password. As such, the mechanism used for access depends on the design of the storage services being used. In general, a public file access API's 2458 and 2460 can be used to acquire files from a first service with credentials A and send files to a second service with credentials B.

The system and method of FIG. 24A resolve the problems associated with the transfer of files stored in the cloud identified above as follows The number of steps required to carry out the action can be reduced, and from the user's point of view the transfer itself is carried out in a single action instead of two, leaving no room for a piloting error during the transfer. The action can be carried out in a single user interface. None of the data need traverse the user's own device or network for the transfer to occur. Finally, by using suitable scheduling routines it is possible to schedule transfers from one provider to another without the presence of the user's own device.

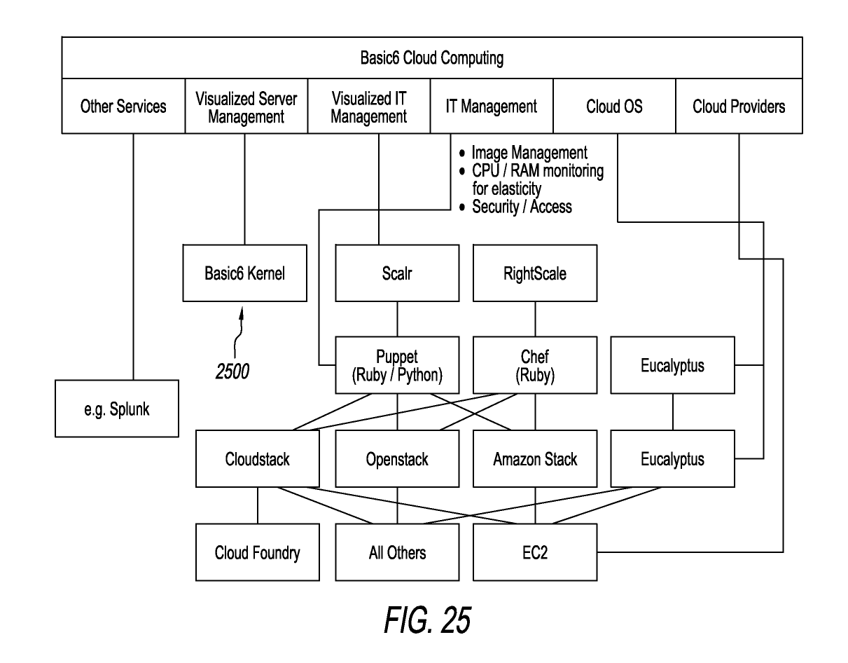

FIG. 25 illustrates further detail of the cloud computing of FIG. 24. The various providers for the services of visualized server management, visualized IT management, IT management, interaction with various cloud operating systems and cloud providers are illustrated. In FIG. 25, the Basic6 kernel 2500 corresponds to the system of the present document; although, at least partly, to a web-enabled version of what has been disclosed herein.

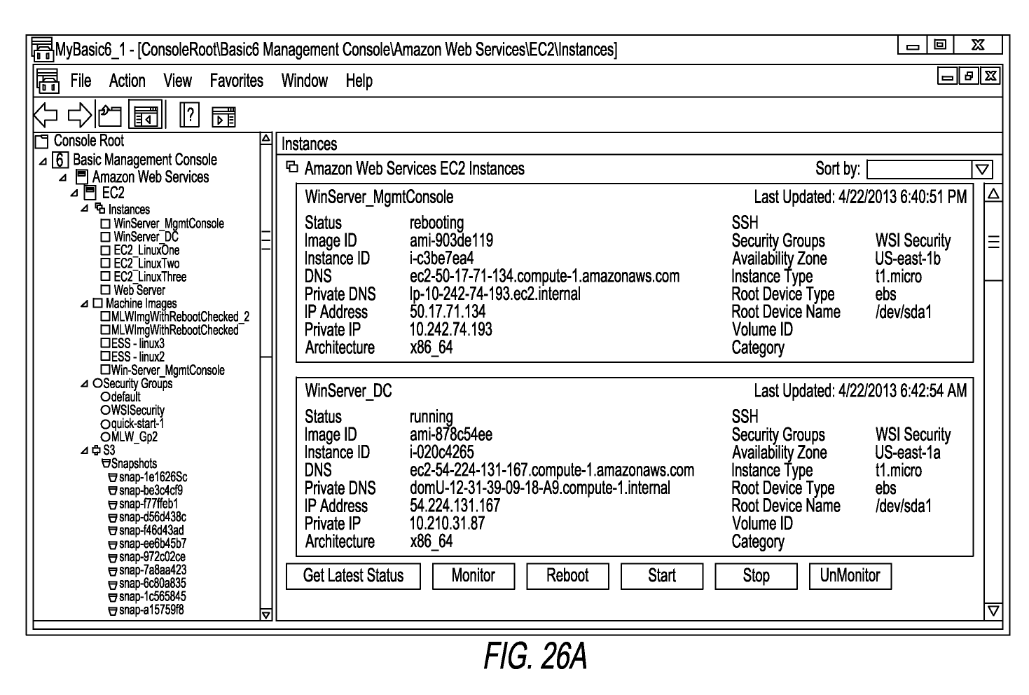

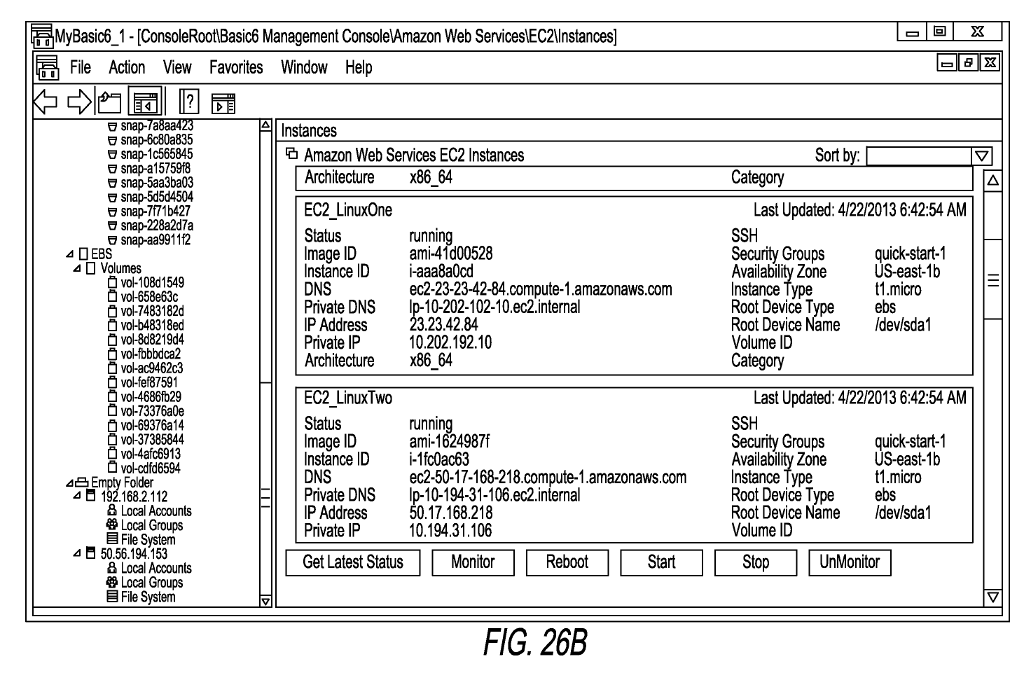

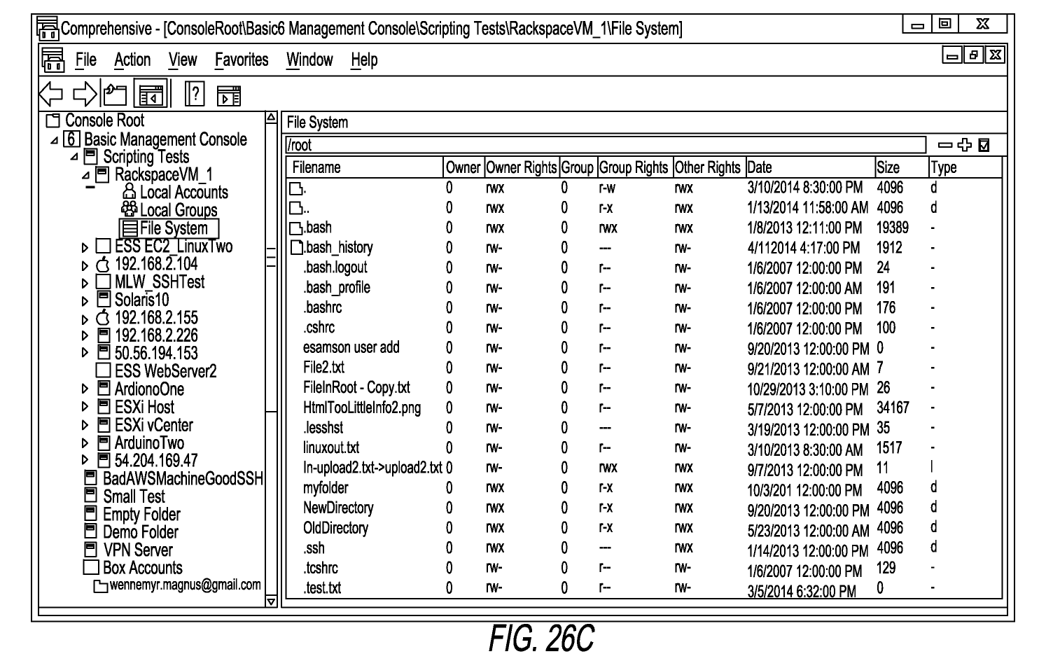

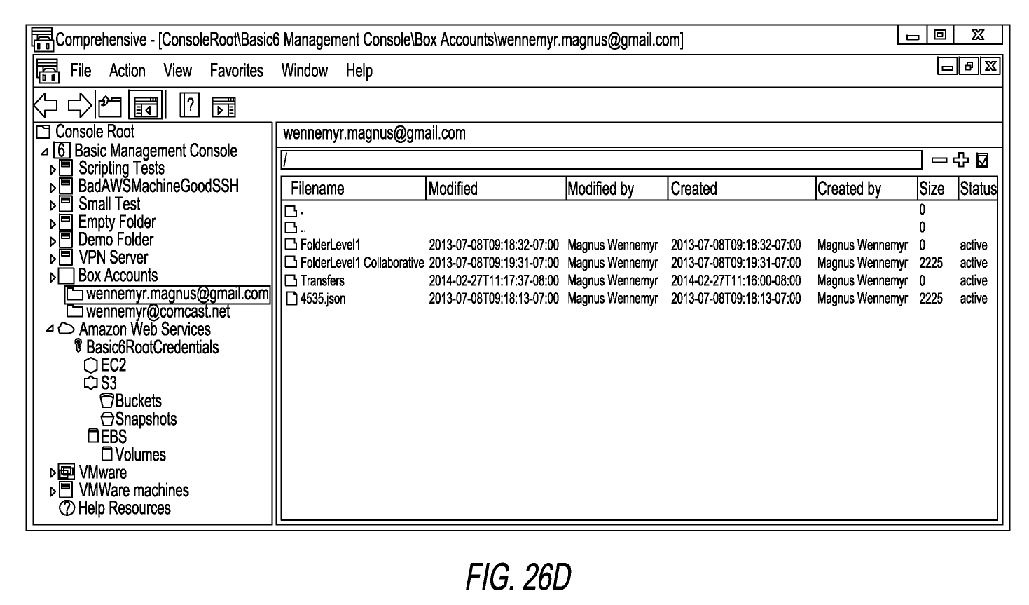

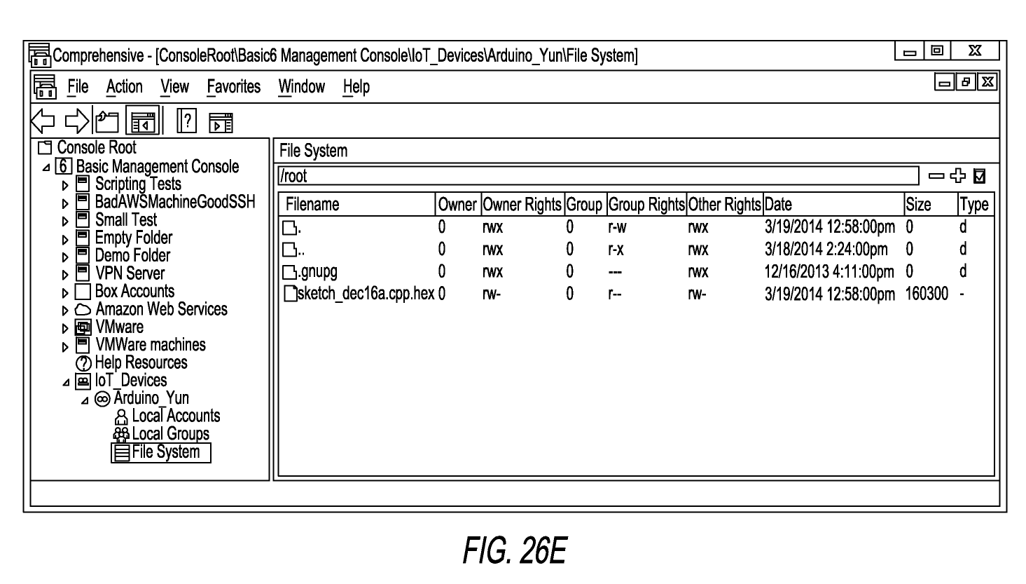

FIGS. 26A and 26B illustrates how AWS EC2 instances are displayed to a user with respect to a list of directories and information concerning each EC2 instance, by console user interface 2015 (FIG. 20). The data blade includes status, image ID, instance ID, DNS, private DNS, IP address, private IP and architecture.

FIG. 26C, FIG. 26D, and FIG. 26E illustrate, respectively, how file systems are depicted to a user on a server, on a cloud service (in this case Box), and on a device (in this case an Arduino Yun).

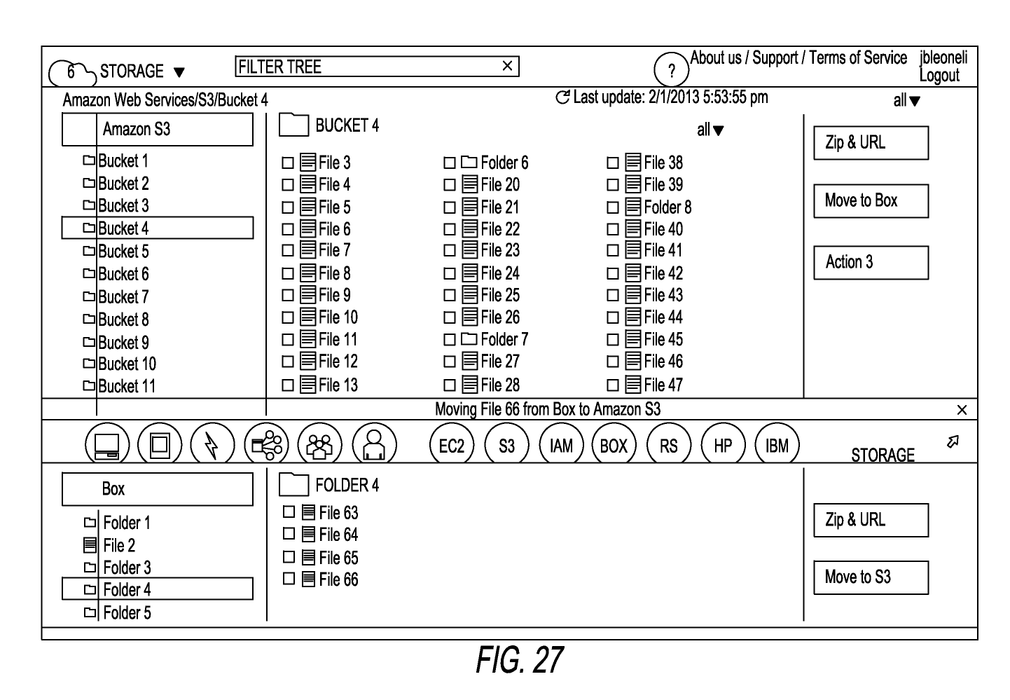

The tools disclosed herein offer security, visibility and control over cloud-based servers allowing the user to manage and troubleshoot in the same manner as any on-premises server. The system and method disclosed herein are public/private cloud and data center agnostic in terms of server management. With full integration into the Windows Microsoft Management Console (“MMC”), the system and method disclosed herein see through cloud-based abstraction to view and control Unix and Linux cloud servers as if they were in a user's datacenter. FIGS. 24, 25 and 27 illustrate the utilization of Application Programming Interfaces (“APIs”) to build the system and method disclosed herein for the creation of a universal management console that snaps into the MMC and accesses all cloud resources including computing, storage, and networking to dynamically provide control, and performance and monitoring across all cloud applications.

The system and method disclosed herein provide agentless technology that extends IT resources, internal management, security and control from inside the data center side of the firewall to the cloud, rather than trying to bridge cloud based management solutions back into a secured network. Duplication of effort between operating systems is removed and the execution and automation of routine administrative tasks via familiar repeatable processes is facilitated. A centralized and standardized single point of control for all non-Microsoft operating systems (Linux & Unix) is created, whether they reside in virtual, data center or cloud environs. No architectural changes are required while utilizing existing technology (e.g., MMC) and leveraging built in security protocols (SSH), with on-demand reporting, enhanced audit controls and built in real time log aggregation monitoring.

By agentless, it is meant that it is not necessary to install specialized software on every server, or every server operating under a different operating system. A single installation in the MMC is all that is required to manage diverse platforms having different operating systems.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A method for transferring data stored in the cloud, comprising:
providing credentials to a service to allow the service to access the data in at least one location in the cloud;
using the service to access data stored in a first location in the cloud; and
using the service to transfer the data accessed at the first location to a second location in the cloud.

2. The method of claim 1, wherein the service is accessed by a user device, and the user device does not acquire the data transferred from the first location to the second location.

3. The method of claim 2, wherein the user device is not connected to the service during the transfer of the data.

4. The method of claim 2, wherein the transfer of the data is scheduled at a time other than when the user device is connected to the service.

5. The method of claim 1, wherein the transfer of the data is scheduled.

6. The method of claim 1, wherein the credentials are in the form of tokens representative of the user's logon information for the plurality of locations in the cloud.

7. The method of claim 6, wherein the tokens are revocable.

8. The method of claim 1, further comprising providing additional credentials to the service to allow the service to store the data in the second location.

9. The method of claim 1, wherein the service is hosted on a domain other than that of the user of the service.

10. The method of claim 1, wherein the transfer of data is accomplished using a single user interface.

11. A system for transferring data stored in the cloud, comprising:
storage for credentials to allow the system to access the data in a plurality of locations in the cloud;
storage for data accessed in a first location in the cloud; and
data transfer components for transferring the data accessed at the first location to a second location in the cloud.

12. The system of claim 11, configured to be accessed by a user device, and the user device does not acquire the data transferred from the first location to the second location.

13. The system of claim 12, wherein the user device is not connected to the service during the transfer of the data.

14. The system of claim 12, wherein the transfer of the data is scheduled at a time other than when the user device is connected to the service.

15. The system of claim 11, wherein the transfer of the data is scheduled.

16. The system of claim 11, wherein the credentials are in the form of tokens representative of the user's logon information for the plurality of locations in the cloud.

17. The system of claim 16, wherein the tokens are revocable.

18. The system of claim 11, wherein additional credentials are used by the service to allow the service to store the data in the second location.

19. The system of claim 11, wherein the service is hosted on a domain other than that of the user of the service.

20. The system of claim 11, wherein the transfer of data is accomplished using a single user interface.
